(19) United States
(12) Patent Application Publication
(10) Pub. No.: US 2007/0225101 A1
(43) Pub. Date: Sep. 27, 2007

(54) Hydraulic pressure control apparatus for automatic transmission

(75) Inventor: Kiyoharu Takagi, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/723,106

(22) Filed: Mar. 16, 2007

(30) Foreign Application Priority Data
Mar. 27, 2006 (JP) 2006-086161

(51) Int. Cl. F16H 31/00

(52) U.S. Cl. 475/116

(57) ABSTRACT

A headrest height adjusting apparatus includes: a basal member attached to a seatback and supporting a driving member; a movable member linked to a headrest and lifted up and down relative to the basal member; a transmitting member transmitting a driving force of the driving member to the movable member and lifting up and down the headrest linked to the movable member. The transmitting member having a frangible portion that leads a collapse of the transmitting member against an impact applied in a vertical direction between the driving member and the movable member and absorbs energy of the impact.

### CROSS REFERENCE TO RELATED APPLICATIONS

This application is based on and claims priority under 35 U.S.C. §119 with respect to Japanese Patent Application 2006-086161, filed on Mar. 27, 2006 the entire content of which is incorporated herein by reference.

### FIELD OF THE INVENTION

The present invention relates to a hydraulic pressure control apparatus for an automatic transmission for simultaneously controlling engaging elements to be in an engaged state or in a disengaged state by means of, for example, a solenoid valve operated by hydraulic pressure from a hydraulic pressure source, and specifically, to a hydraulic pressure control apparatus that can achieve at least seven forward shift stages.

### BACKGROUND

A known hydraulic pressure control apparatus for an automatic transmission employs a so called clutch-to-clutch control system by which each engaging element is simultaneously controlled to be in an engaged state or in a disengaged state, by means of a solenoid valve (linear solenoid valve) directly operated by hydraulic pressure from the hydraulic pressure source, in order to provide a smooth and high level response shift feeling. JP2005-163916A (Reference 1) discloses a hydraulic pressure control apparatus having a failsafe valve for the purpose of avoiding an interlock of a shifting mechanism at an event of failure.

In Reference 1, the automatic transmission incorporates, therein, three engaging elements C-3, B-1 and C-4. According to the hydraulic pressure control apparatus disclosed in JP2005-163916A, a failsafe valve is arranged between a hydraulic servo (53, 55 and 54 in FIG. 4 of Reference 1) for each engaging element and a hydraulic pressure source (20 in FIG. 4 thereof). Hydraulic pressure supply to the hydraulic servo (53) is established or interrupted by the first failsafe valve (43 in FIG. 4 thereof) that is selectively operated by a first solenoid valve (36) arranged so as to correspond to the first failsafe valve. Likewise, hydraulic pressure supply to the hydraulic servo (55) is established or interrupted by the second failsafe valve (45) that is selectively operated by a second solenoid valve (37). The third failsafe valve (44) is selectively operated via both of the first and second failsafe valves by a third failsafe valve switching hydraulic pressure applied. Therefore, the failsafe valves are firmly switched by the solenoid valves, which is less in quantity than the failsafe valves, respectively. In the event of an off-failure for a solenoid signal, because the solenoid valves for a clutch C1, a clutch C2 and a clutch C4 (a corresponding engaging element) is a normally high type (NH; outputs hydraulic pressure at the maximum pressure level in the de-energized state), a cutoff valve (41, failsafe valve) discontinues supply of the pressure C1 during one of the fifth, seventh and eighth shift stage being selected with the pressure C2 being supplied. In this case, a vehicle can drive at the sixth shift stage with the clutches C4 and C4 engaged. During any of the first, second third and fourth shift stages with the pressure C2 being supplied, a vehicle can drive at the fourth shift stage with the clutches C1 and C4.

According to a hydraulic pressure control apparatus for an automatic transmission having failsafe valves, the failsafe valve is not operated during the shift mode and is operated during a fixed shift stage mode. Here, the hydraulic pressure supplied to the engaging element to be engaged (output pressure of control valve) is not switched by a hydraulic balance that is delicate as a signal pressure and is turned on or off by an on-off solenoid valve, so that the switching of the failsafe valve is assured. Further, an operation condition of other failsafe valve can be switched in accordance with a combination of operations of the on-off solenoid valves. Therefore, it is possible to reduce the number of on-off solenoid valves. However, according to an embodiment disclosed in Reference 1, control valves (24, 31-35 in FIG. 4 of Reference 1) is a direct pressure type valve that is not structured with a combination of a linear solenoid valve and a control valve and does not use a modulator pressure. From the view of the current development of such direct pressure type valve, a normally high-type and direct pressure type valve (NH) has not been utilized yet. A normally low-type (NL; not outputs hydraulic pressure in the de-energized state) valve depends on electromagnetic force and hydraulic pressure. A normally high-type valve (NH) depends on electromagnetic force only, and hydraulic pressure is less outputted in response to an increase in electric current. Therefore, in order to drive a vehicle during an off failure, it is necessary to change an oil passage or add another valves (at least another two or three valves) by use of a method disclosed in JP2005-24059A. Further, in Reference 1, the failsafe valve is operated even during a fixed shift stage mode. Therefore, there is a possibility of interlock due to a primary failure of a failsafe valve.

A need thus exist to provide a hydraulic pressure control apparatus which shows improved safety and can achieve at least seventh shift stage only with minor changes of the oil passage structure for the sixth shift stage.

### SUMMARY OF THE INVENTION

According to an aspect of the present invention, a hydraulic pressure control apparatus for an automatic transmission has a plurality of engaging elements. By the apparatus, a shift stage is switched in accordance with a combination of supplying hydraulic pressure to at least one of the engaging elements and draining hydraulic pressure from at least one of the engaging elements. The apparatus includes: a plurality of control valves each generating control hydraulic pressure from line pressure in response to an amount of electric power supplied thereto and controlling engagement or disengagement of at least one corresponding engaging element from among the engaging elements by use of the control hydraulic pressure; a plurality of shift valves each responsive to be actuated by a signal pressure and selectively establishing an oil passage for supplying the line pressure to each control valve in response to the signal pressure; a plurality of on-off solenoid valves each controlled in an energized state or in a de-energized state and each switching the signal pressure for a corresponding shift valve from among the plurality of shift valves in response the energized or de-energized state; a shift mode under which the plural shift valves are actuated to open the oil passages for supplying the line pressure to all of the corresponding control valves in accordance with a combination of the on-off solenoid valves in the energized or de-energized state: a fixed shift mode under which the plural shift valves are actuated to open at least one of the oil passages for supplying the line pressure to the corresponding control valve so that at least one corresponding engaging element from among the engaging elements is engaged and a shift stage is established in the automatic transmission; and an additional control valve provided to increase the number of shift stages achievable in the automatic transmission. The plural shift valves each supply the line pressure to the additional control valve only during the fixed shift mode.

### BRIEF DESCRIPTION OF THE DRAWINGS

The foregoing and additional features and characteristics of the present invention will become more apparent from the following detailed description considered with reference to the accompanying drawings, wherein:

FIG. 1 is a view illustrating an entire structure of a hydraulic pressure control apparatus for an automatic transmission according to a first embodiment of the present invention;

FIG. 2 is a schematic view of the automatic transmission according to the first embodiment.

FIG. 3 is a table explaining relationships between combinations of the engaging elements C1, C2, C3, C4, B1 and B2 to be engaged or disengaged and shifts stage corresponding to each combination according to the first embodiment;

FIG. 4 is a hydraulic circuit diagram partially schematically illustrating a structure of the hydraulic pressure control unit according to the first embodiment of the present invention;

FIG. 5 is a table for explaining a shift pattern at each driving range selected in accordance with a control state of the hydraulic pressure control unit according to the first embodiment;

FIG. 6 is a hydraulic circuit diagram partially schematically illustrating a structure of a hydraulic pressure control unit according to a second embodiment of the present invention;

FIG. 7 is a table for explaining a shift pattern at each driving range selected in accordance with a control state of the hydraulic pressure control unit according to the second embodiment;

FIG. 8 is a hydraulic circuit diagram partially schematically illustrating a structure of a hydraulic pressure control unit according to the third embodiment of the present invention;

FIG. 9 is a table for explaining a shift pattern at each driving range selected in accordance with a control state of the hydraulic pressure control unit according to the third embodiment;

FIG. 10 is a hydraulic circuit diagram partially schematically illustrating a structure of a hydraulic pressure control unit according to a fourth embodiment of the present invention;

FIG. 11 is a table for explaining a shift pattern at each driving range selected in accordance with a control state of the hydraulic pressure control unit according to the fourth embodiment;

FIG. 12 is a hydraulic circuit diagram partially schematically illustrating a structure of a hydraulic pressure control unit according to a fifth embodiment of the present invention;

FIG. 13 is a table for explaining a shift pattern at each driving range selected in accordance with a control state of the hydraulic pressure control unit according to the fifth embodiment;

FIG. 14 is a hydraulic circuit diagram partially schematically illustrating a structure of a hydraulic pressure control unit according to a sixth embodiment of the present invention;

FIG. 15 is a table for explaining a shift pattern at each driving range selected in accordance with a control state of the hydraulic pressure control unit according to the sixth embodiment;

FIG. 16 is a hydraulic circuit diagram partially schematically illustrating a structure of a hydraulic pressure control unit according to a seventh embodiment of the present invention;

FIG. 17 is a table for explaining a shift pattern at each driving range selected in accordance with a control state of the hydraulic pressure control unit according to the seventh embodiment;

FIG. 18 is a hydraulic circuit diagram schematically illustrating a hydraulic pressure control unit according to an example 1;

FIG. 19 is a table for explaining a shift pattern at each driving range selected in accordance with a control state of the hydraulic pressure control unit according to the seventh embodiment;

FIG. 20A is a shift operation diagram for a 6-speed AT according to the example 1;

FIG. 20B is a shift operation diagram for an 8-speed AT for an 8-speed AT according to the first embodiment;

FIG. 21A is a shift operation diagram for a 6-speed AT according to an example 2; and

FIG. 21B is a shift operation diagram for an 8-speed AT according to Reference 1.

### DETAILED DESCRIPTION

Embodiments of the present invention will be described below with reference to the attached drawings.

### First Embodiment

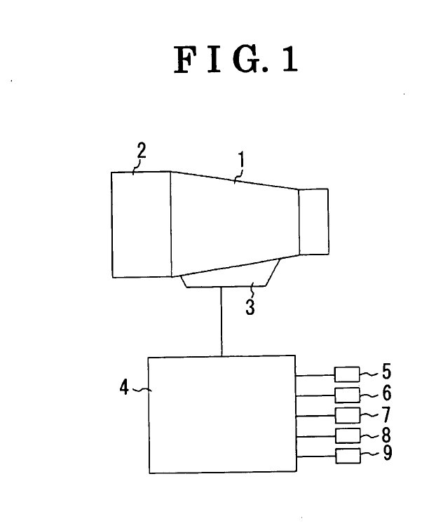

Described below is a hydraulic pressure control apparatus for an automatic transmission according to the first embodiment of the present invention, with reference to the attached drawings. FIG. 1 is a view illustrating an entire structure of the hydraulic pressure control apparatus for an automatic transmission according to the first embodiment of the present invention. The hydraulic pressure control apparatus for an automatic transmission includes: an automatic transmission 1; a hydraulic pressure control unit 3 and an electronic control unit 4. The automatic transmission 1 is connected to an output shaft (not illustrated) of an engine 2. The hydraulic pressure control unit 3 controls supply of hydraulic pressure to hydraulically driven type engaging elements (not illustrated) housed in the automatic transmission 1. The electronic control unit 4 controls actuation of solenoid valves (not illustrated) housed in the hydraulic pressure control unit 3.

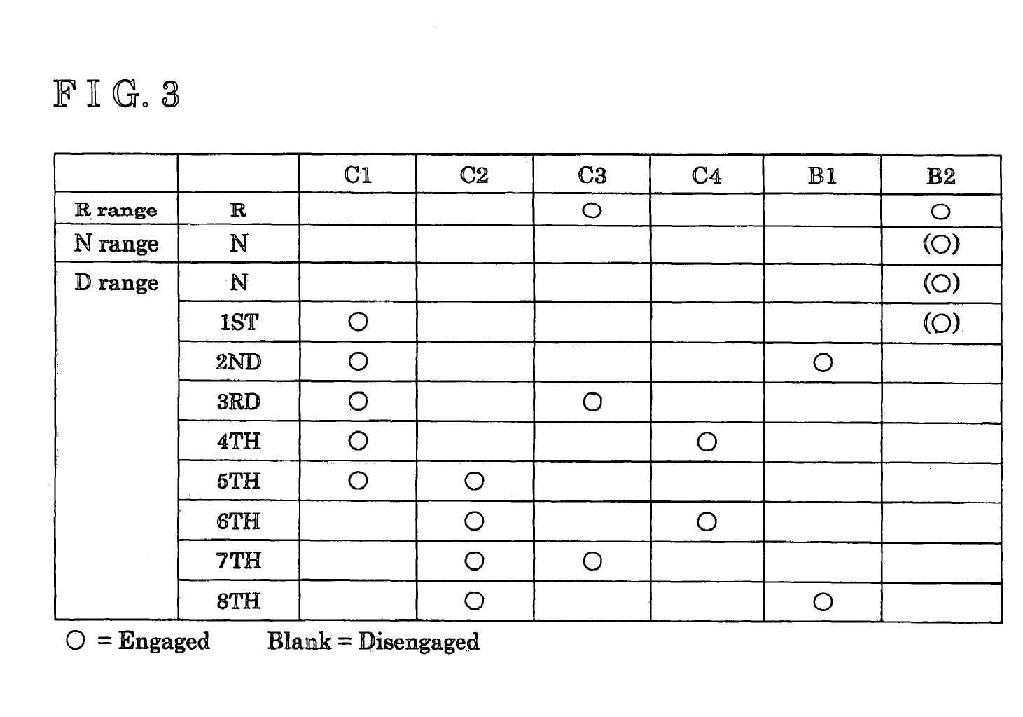

The electronic control unit 4 incorporates, therein, a microcomputer and is connected to an engine rotational speed sensor (Ne sensor) 5, an input shaft rotational speed sensor (Nt sensor) 6, an output shaft rotational speed sensor (No sensor) 7, an opening degree sensor (θ sensor) 8 and a position sensor 9. The engine rotational speed sensor (Ne sensor) 5 detects a rotational speed Ne of the output shaft of an engine 2. The input shaft rotational speed sensor (Nt sensor) 6 detects a rotational speed Nt of an input shaft 11 of the automatic transmission 1. The output shaft rotational speed sensor (No sensor) 7 detects a rotational speed No of an output shaft 12 of the automatic transmission 1. The rotational speed No of an output shaft 12 corresponds to a speed of a vehicle. The opening degree sensor (θ sensor) 8 detects an opening degree θ of a throttle valve of the engine 2. The opening degree θ of the throttle valve of the engine 2 corresponds to a load applied to the engine 2. The position sensor 9 detects a position (driving range) of a shift lever operated by a driver. The electronic control unit 4 controls, based upon outputs of the sensors 5, 6, 7, 8 and 9, electric power supply (energizing or de-energizing) to control valve units (control valves) SL1, SL2, SL3 and SL4 and on-off solenoid valves S1, S2 and S3. Accordingly, a desired shift stage is achieved (see FIG. 3).

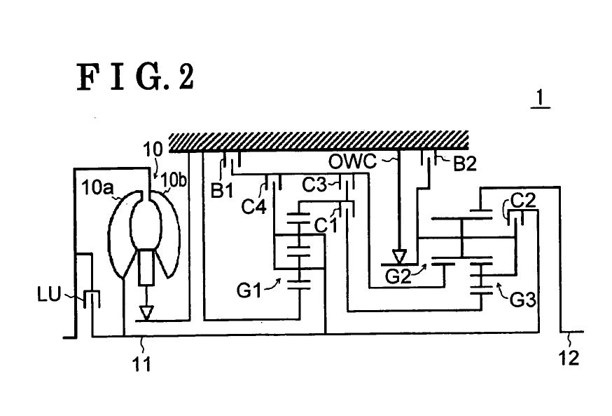

FIG. 2 is a schematic view of the automatic transmission 1 according to the first embodiment. The automatic transmission 1 enables to achieve eight forward shift stages and includes a torque converter 10, the input shaft 11, the output shaft 12, a first double-pinion planetary gear train G1, a second single-pinion planetary gear train G2, and a third double-pinion planetary gear train G3. The torque converter 10 is connected to the output shaft of the engine 2 and includes a pump impeller 10b at its input side, a turbine runner 10a at its output side, and a lock-up clutch LU frictionally engaged by a pressure difference. In case where a rotational speed difference between the pump impeller 10b and the turbine runner 10a is small, the lock-up clutch LU is engaged and aids transmitting the input torque of the torque converter 10 to the gear box. The input shaft 11 is an output shaft of the torque converter 10. The output shaft 12 is connected to an axis via a differential gear (not illustrated). The first double-pinion planetary gear train G1, the second single-pinion planetary gear train G2 and the third double-pinion planetary gear train G3 are mutually connected between the input shaft 11 and the output shaft 11 as illustrated in FIG. 2. The automatic transmission 1 incorporates, therein, plural engaging elements. According to the first embodiment, there are seven engaging elements: a first frictional clutch C1, a second frictional clutch C2, a third frictional clutch C3, a fourth frictional clutch C4, a first frictional brake B1, a second frictional brake B2 and the lock-up clutch LU. The hydraulic pressure control unit 3 and the electronic control unit 4 selectively control engagements and disengagements of the frictional clutches C1, C2, C3 and C4 and the frictional brakes B1 and B2, and thus a shift stage and a shift pattern is selectively established in the automatic transmission 1. The hydraulic pressure control unit 3 and the electronic control unit 4 further control the engagement and disengagement of the lock-up clutch LU. The lock-up clutch LU is frictionally engaged when a rotational speed difference between the pump impeller 10b and the turbine runner 10a of the torque converter 10 is small during the vehicle driving at the forward shift stage. The second single-pinion planetary gear train G2 can be provided with a one-way clutch OWC arranged in parallel with the second frictional brake B2. The frictional clutches C1, C2, C3 and C4, the frictional brake B1 and B2 and the lock-up clutch LU are frictionally engaged when being applied with a high-leveled hydraulic pressure by the hydraulic pressure control unit 3, while they are frictionally disengaged when being applied with a low-leveled hydraulic pressure thereby. The second frictional brake B2 can be structured with mechanically separated brakes B2S and B2L.

FIG. 3 is a table explaining relationships between combinations of the engaging elements C1, C2, C3, C4, B1 and B2 to be engaged or disengaged and shifts stage corresponding to each combination according to the first embodiment. The automatic transmission 1 is applicable to effect eight forward and single reverse shift stages. The eight forward shift stages is represented by under-drive shift stages, which are 1st, 2nd, 3rd, 4th and 5th shift stages, and over-drive shift stages, which are 6th, 7th and 8th shift stages. It is obvious that the automatic transmission 1 is applicable to achieve a neutral shift stage as well. More specifically, the output shaft 12 is rotated in an opposite direction of the input shaft 11 when only the third frictional clutch C3 and the second frictional brake B2 are frictionally engaged. In this case, the vehicle drives rearward. The neutral shift stage is established when only the second frictional brake B2 is engaged. The 1st shift stage is established when only the first frictional clutch C1 is engaged. The 1 st shift stage can be established when the second frictional brake B2 is also engaged. The 2nd shift stage is established only with the first frictional clutch C1 and the first frictional brake B1 frictionally engaged. The 3rd shift stage is established only with the 1 st frictional clutch C 1 and the 3rd frictional clutch C3 frictionally engaged. The 4th shift stage is established only with the first frictional clutch C1 and the fourth frictional clutch C4 frictionally engaged. The 5th shift stage is established only with the first frictional clutch C1 and the second frictional clutch C2 frictionally engaged. The 6th shift stage is established only with the second frictional clutch C2 and the fourth frictional clutch C4 frictionally engaged. The 7th shift stage is established only with the second frictional clutch C2 and the third frictional clutch C3 frictionally engaged. The 8th shift stage is established only with the second frictional clutch C2 and the first frictional brake B1 frictionally engaged. The table in FIG. 3 also explains a relationship between the shift stage and a driving range (R range, N range, D range) selected in response to an operation of a manual lever (not illustrated) by a driver.

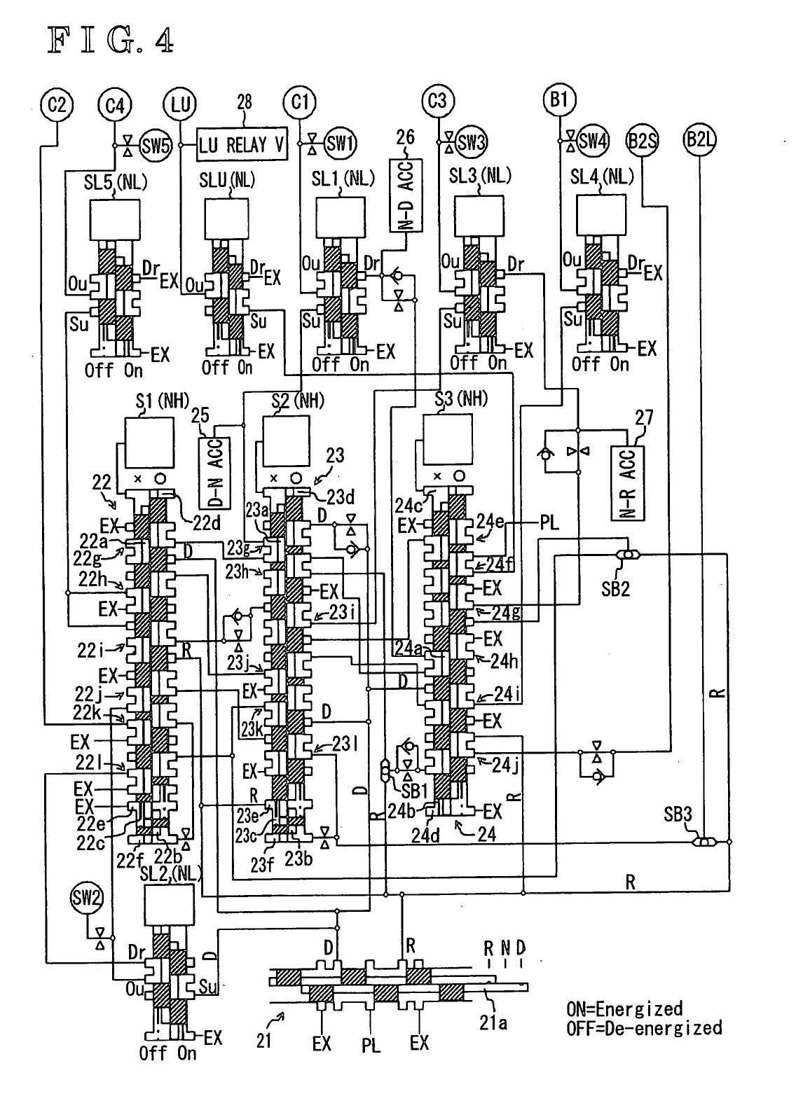

Described below is a structure and controlling of the hydraulic pressure control unit according to the first embodiment with reference to the attached drawings. FIG. 4 is a hydraulic circuit diagram partially schematically illustrating a structure of the hydraulic pressure control unit according to the first embodiment of the present invention.

The hydraulic pressure control unit 3 includes control valve units SL1, SL2, SL3, SL4, SL5 and SLU, a manual valve 21, shift valves 22, 23 and 24, on-off solenoid valves S1, S2 and S3, a D-N accumulator 25, a N-D accumulator 26, a N-R accumulator 27, hydraulic switches SW1, SW2, SW3, SW4 and SW5, an LU relay valve 28, and shuttle valves SB1, SB2 and SB3.

The first control valve unit (control valve) SL1 is a control valve unit for the first frictional clutch C1 and is integrated with a linear solenoid valve and a spool valve. The first control valve unit SL1 can be structured with a linear solenoid valve and a spool valve, which are mechanically isolated from each other. The spool valve of the first control valve unit SL1 is selectively movable in response to an amount of electric power supplied to the linear solenoid valve of the first control valve unit SL1. The spool valve of the first control valve unit SL1 is formed with a supply port through which an output pressure (pressure D) of the first switching circuit 23g of the second shift valve 23 is introduced. In the first control valve unit SL1, a control hydraulic pressure is generated in response to an amount of electric power supplied to the linear solenoid valve of the first control valve unit SL1. The control hydraulic pressure is generated from the output pressure (pressure D) of the first switching circuit 23g of the second shift valve 23, which is introduced to the spool valve the first control valve unit SL1. The control hydraulic pressure is outputted via an output port of the spool valve. In the situation where the first control valve unit SL1 is supplied with: 1) the output pressure (pressure D) of the first switching circuit 23g of the second shift valve 23 introduced via the supply port; and 2) an output pressure (pressure D) of a fourth switching circuit 24h of the third shift valve 24 introduced via a drain port thereof, the pressure D is outputted from the output port, regardless if the linear solenoid valve is energized or de-energized. The output pressure (pressure SL1) of the first control valve unit SL1 is supplied to the first frictional clutch C1 and the first hydraulic switch SW1. The first control valve unit SL1 is a normally low-type valve unit (NL), which doest not output the pressure SL1 in the de-energized state and incrementally outputs the pressure SL1 in response to an increase in the amount of electric power supplied in the energized state. The output port of the first control valve unit SL1 fluidly communicates with the drain port thereof in the de-energized state.

The second control valve unit (control valve) SL2 is a control valve unit for the second frictional clutch C2 and the second frictional brake B2L and is integrated with a linear solenoid valve and a spool valve. The second control valve unit SL2 can be structured with a linear solenoid valve and a spool valve, which are mechanically isolated from each other. The spool valve of the second control valve unit SL2 is selectively movable in response to an amount of electric power supplied to the linear solenoid valve of the second control valve unit SL2. The spool valve of the second control valve unit SL2 is formed with a supply port through which an output pressure (pressure D) of the manual valve 21 is introduced. In the second control valve unit SL2, a control hydraulic pressure is generated in response to an amount of electric power supplied to the linear solenoid valve of the second control valve unit SL2. The control hydraulic pressure is generated from the output pressure (pressure D) of the manual valve 21, which is introduced to the spool valve the second control valve unit SL2. The control hydraulic pressure is outputted via an output port of the spool valve. In the situation where the second control valve unit SL2 is supplied with: 1) the output pressure (pressure D) of the manual valve 21 introduced via the supply port; and 2) an output pressure (pressure D) of a sixth switching circuit 221 of the first shift valve 22 introduced via a drain port thereof, the pressure D is outputted from the output port, regardless if the linear solenoid valve is energized or de-energized. The output pressure (pressure SL2) of the second control valve unit SL2 is supplied to the second hydraulic switch SW2. The output pressure (pressure SL2) of the second control valve unit SL2 is further supplied to the second frictional clutch C2 via a fifth switching circuit 22k of the first shift valve 22 in the case where a spool of the first shift valve 22 is positioned as denoted with a symbol “∘”. The output pressure (pressure SL2) of the second control valve unit SL2 is still further supplied to the second frictional brake B2L via a third switching circuit 22i of the first shift valve 22, a sixth switching circuit 231 of the second shift valve 23 and a third shuttle valve SB3 in case where a spool of the first shift valve 22 is positioned as denoted with a symbol “x” and a spool of the second shift valve 23 is positioned as denoted with a symbol “∘”. The second control valve unit SL2 is a normally low-type valve unit (NL), which doest not output the pressure SL2 in the de-energized state and incrementally outputs the pressure SL2 in response to an increase in the amount of electric power supplied to the linear solenoid thereof in the energized state. The output port of the second control valve unit SL2 fluidly communicates with the drain port thereof in the de-energized state.

The third control valve unit (control valve) SL3 is a control valve unit for the third frictional clutch C3 and is integrated with a linear solenoid valve and a spool valve. The third control valve unit SL3 can be structured with a linear solenoid valve and a spool valve, which are mechanically isolated from each other. The spool valve of the third control valve unit SL3 is selectively movable in response to an amount of electric power supplied to the linear solenoid valve of the third control valve unit SL3. The spool valve of the third control valve unit SL3 is formed with a supply port through which an output pressure (pressure PL or R) of a third switching circuit 23i of the second shift valve 23 is introduced. In the third control valve unit SL3, a control hydraulic pressure is generated in response to an amount of electric power supplied to the linear solenoid valve of the third control valve unit SL3. The control hydraulic pressure is generated from the output pressure (pressure PL or R) of the third switching circuit 23i of the second shift valve 23, which is introduced to the spool valve the third control valve unit SL3. The control hydraulic pressure is outputted via an output port of the spool valve. In the situation where the third control valve unit SL3 is supplied with: 1) the output pressure (pressure PL or R) of the third switching circuit 23i of the second shift valve 23 introduced via the supply port; and 2) an output pressure (pressure D or R) of a third switching circuit 24g of the third shift valve 24 introduced via a drain port thereof, the line pressure is outputted from the output port, regardless if the linear solenoid valve of the third control valve unit SL3 is energized or de-energized. The output pressure (pressure SL3) of the third control valve unit SL3 is supplied to the third frictional clutch C3 and the third hydraulic switch SW3. The third control valve unit SL3 is a normally low-type valve unit (NL), which doest not output the pressure SL3 in the de-energized state and incrementally outputs the pressure SL3 in response to an increase in the amount of electric power supplied in the energized state. The output port of the third control valve unit SL3 fluidly communicates with the drain port thereof in the de-energized state.

The fourth control valve unit (control valve) SL4 is a control valve unit for the first frictional brake B1 and is integrated with a linear solenoid valve and a spool valve. The fourth control valve unit SL4 can be structured with a linear solenoid valve and a spool valve, which are mechanically isolated from each other. The spool valve of the fourth control valve unit SL4 is selectively movable in response to an amount of electric power supplied to the linear solenoid valve of the fourth control valve unit SL4. The spool valve of the fourth control valve unit SL4 is formed with a supply port through which an output pressure (pressure D) of the fifth switching circuit 24i of the third shift valve 24 is introduced. In the fourth control valve unit SL4, a control hydraulic pressure (pressure SL4) is generated in response to an amount of electric power supplied to the linear solenoid valve of the fourth control valve unit SL4. The control hydraulic pressure (pressure SL4) is generated from the output pressure (pressure D) of the fifth switching circuit 24i of the third shift valve 24, which is introduced to the spool valve the fourth control valve unit SL4. The control hydraulic pressure is outputted via an output port of the spool valve. The drain port of the fourth control valve unit SL4 communicates with an exhaust circuit (EX). The pressure SL4 is supplied to the first frictional brake B1 and the fourth hydraulic switch SW4. The fourth control valve unit SL4 is a normally low-type valve unit (NL), which doest not output the pressure SL4 in the de-energized state and incrementally outputs the pressure SL4 in response to an increase in the amount of electric power supplied in the energized state. The output port of the fourth control valve unit SL4 fluidly communicates with the drain port thereof in the de-energized state.

The fifth control valve unit (additional control valve) SL5 is a control valve unit for the fourth frictional clutch C4 and is integrated with a linear solenoid valve and a spool valve. The fifth control valve unit SL5 can be structured with a linear solenoid valve and a spool valve, which are mechanically isolated from each other. The spool valve of the fifth control valve unit SL5 is selectively movable in response to an amount of electric power supplied to the linear solenoid valve of the fifth control valve unit SL5. The spool valve of the fifth control valve unit SL5 is formed with a supply port through which an output pressure (pressure D) of a second switching circuit 22h of the first shift valve 22 is introduced. In the fifth control valve unit SL5, a control hydraulic pressure (pressure SL5) is generated in response to an amount of electric power supplied to the linear solenoid valve of the fifth control valve unit SL5. The control hydraulic pressure (pressure SL5) is generated from the output pressure (pressure D) of the second switching circuit 22h of the first shift valve 22, which is introduced to the spool valve the fifth control valve unit SL5. The control hydraulic pressure (pressure SL5) is outputted via an output port of the spool valve. The drain port of the fifth control valve unit SL5 communicates with an exhaust circuit (EX). The pressure SL5 is supplied to the fourth frictional clutch C4 and the fifth hydraulic switch SW5. The fifth control valve unit SL5 is a normally low-type valve unit (NL), which doest not output the pressure SL5 in the de-energized state and incrementally outputs the pressure SL5 in response to an increase in the amount of electric power supplied in the energized state. The output port of the fifth control valve unit SL5 fluidly communicates with the drain port thereof in the de-energized state.

The LU control valve unit (control valve) SLU is a control valve unit for the lockup clutch LU and is integrated with a linear solenoid valve and a spool valve. The LU control valve unit SLU can be structured with a linear solenoid valve and a spool valve, which are mechanically isolated from each other. The spool valve of the LU control valve unit SLU is selectively movable in response to an amount of electric power supplied to the linear solenoid valve of the LU control valve unit SLU. The spool valve of the LU control valve unit SLU is formed with a supply port through which an output pressure (pressure PL) of a second switching circuit 24f of the third shift valve 24 is introduced. In the LU control valve unit SLU, a control hydraulic pressure (pressure SLU) is generated in response to an amount of electric power supplied to the linear solenoid valve of the LU control valve unit SLU. The control hydraulic pressure (pressure SLU) is generated from the output pressure (pressure D) of the second switching circuit 24f of the third shift valve 24, which is introduced to the spool valve the fifth control valve unit SLU. The control hydraulic pressure (pressure SLU) is outputted via an output port of the spool valve. The pressure SLU is supplied to the lockup clutch LU and the LU relay valve 28. The LU control valve unit SLU is a normally low-type valve unit (NL), which doest not output the pressure SLU in the de-energized state and incrementally outputs the pressure SLU in response to an increase in the amount of electric power supplied in the energized state. The output port of the LU control valve unit SLU fluidly communicates with the drain port (exhaust circuit; EX) thereof in the de-energized state.

The manual valve 21 switches a hydraulic circuit in association with a driving range selected based upon an operation of a manual lever (not illustrated). The manual valve 21 incorporates therein a spool 21a slidably movable in a casing in association with an operation of the manual lever. When the D range is selected, the pressure PL, which is inputted thereinto via its pressure PL port, is outputted via its pressure D port as the pressure D. When the R range is selected, the pressure PL, which is inputted thereinto via its pressure PL port, is outputted via its pressure R port as the pressure R. The output pressure (pressure D) outputted from the pressure D port of the manual valve 21 is supplied to the supply port of the second control valve unit SL2, the first switching circuit 22g of the first shift valve 22, the first switching circuit 23g and a fifth switching circuit 23K of the second shift valve 23, and the fifth switching circuit 24i of the third shift valve 24. The output pressure (pressure R) outputted from the pressure R port of the manual valve 21 is supplied to the third switching circuit 22i of the first shift valve 22, the second hydraulic chamber 23e of the second shift valve 23, the second shuttle valve SB2 and the third shuttle valve SB3.

The first shift valve 22 is a switching valve for selectively establishing an oil passage and incorporates, in its valve body, a first spool 22a, a second spool 22b, a spring 22c, a first hydraulic chamber 22d, a second hydraulic chamber 22e, and a third hydraulic chamber 22f. The first spool 22a is arranged to be slidable within the valve body (not illustrated). The second spool 22b is arranged at an opposite side to the first spool 22a relative to the spring 22c in the valve body (not illustrated) and is slidably positioned in the valve body. The spring 22c, which is arranged in the second hydraulic chamber 22e, biases the first spool 22a towards the first hydraulic chamber 22d and the second spool 22b towards the third hydraulic chamber 22f. When the first shift valve 22 is inputted with a signal pressure of the first on-off solenoid valve S1, the first hydraulic chamber 22d is actuated so as to bias the first spool 22a towards the third hydraulic chamber 22f. The second hydraulic chamber 22e is a hydraulic chamber communicating with an exhaust port (exhaust circuit; EX) of the first shift valve 22. When an hydraulic pressure (pressure C2) for the second frictional clutch C2 is introduced to the first shift valve 22, the third hydraulic chamber 22f is actuated so as to bias the second spool 22b towards the first hydraulic chamber 22d. In case where a force level of the hydraulic pressure applied by the first hydraulic chamber 22d is higher than the sum of the biasing force of the spring 22c and the hydraulic pressure applied by the third hydraulic chamber 22f, the first spool 22a is slidably moved towards the third hydraulic chamber 22f(“x” in FIG. 4). In an opposite case thereto, the first spool 22a is slidably moved towards the first hydraulic chamber 22d (“∘”). The first spool 22a of the first shift valve 22 is formed with a first switching circuit 22g. Because of this structure having the first switching circuit 22g, when the first spool 22a is positioned as denoted with “x” in FIG. 4, a fluid communication is established among the first switching circuit 23g and the second switching circuit 23h of the second shift valve 23, the fourth switching circuit 24h of the third shift valve 24 and the pressure D port of the manual valve 21. On the other hand, when the first spool 22a is positioned as denoted with “∘” in FIG. 4, a fluid communication is established among the first switching circuit 23g and the second switching circuit 23h of the second shift valve 23, the fourth switching circuit 24h and an exhaust port (EX) of the first shift valve 22. The first shift valve 22 further includes the second switching circuit 22h. Because of this structure having the second switching circuit 22h, when the first spool 22a is positioned as denoted with “x” in FIG. 4, the supply port of the fifth control valve unit SL5 fluidly communicates with the exhaust port (EX) of the first shift valve 22. On the other hand, when the first spool 22a is positioned as denoted with “∘” in FIG. 4, the supply port of the fifth control valve unit SL5 fluidly communicates with the fourth switching circuit 23j of the second shift valve 23. The first shift valve 22 still further includes the third switching circuit 22i. Because of this structure having the third switching circuit 22i, when the first spool 22a is positioned as denoted with “x” in FIG. 4, the third switching circuit 23i of the second shift valve 23 fluidly communicates with the pressure R port of the manual valve 21. On the other hand, when the first spool 22a is positioned as denoted with “∘” in FIG. 4, the supply port of the fifth control valve unit SL5 fluidly communicates with the third switching circuit 23i of the second shift valve 23. The first shift valve 22 still further includes a fourth switching circuit 22j. Because of this structure having the fourth switching circuit 22j, when the first spool 22a is positioned as denoted with “∘” in FIG. 4, the sixth switching circuit 231 of the second shift valve 23 fluidly communicates with an exhaust port (EX) of the first shift valve 22. On the other hand, when the first spool 22a is positioned as denoted with “x” in FIG. 4, a fluid communication is established among the sixth switching circuit 231 of the second shift valve 23, the output port of the second control valve unit SL2 and the second hydraulic switch SW2. The first shift valve 22 still further includes the fifth switching circuit 22k. Because of this structure having the fifth switching circuit 22k, when the first spool 22a is positioned as denoted with “x” in FIG. 4, a fluid communication is established among the second frictional clutch C2, the third hydraulic chamber 22f and an exhaust port (EX) of the first shift valve 22. On the other hand, when the first spool 22a is positioned as denoted with “∘” in FIG. 4, a fluid communication is established among the second frictional clutch C2, the third hydraulic chamber 22f of the first shift valve 22, the output port of the second control valve unit SL2 and the second hydraulic switch SW2. The first shift valve 22 still further includes the sixth switching circuit 221. Because of this structure having the sixth switching circuit 221, when the first spool 22a is positioned as denoted with “∘” in FIG. 4, a fluid communication is established among a drain port of the second control valve unit SL2, the fifth switching circuit 23k of the second shift valve 23 and the second shuttle valve SB2. On the other hand, when the first spool 22a is positioned as denoted with “x” in FIG. 4, the drain port of the second control valve unit SL2 fluidly communicates with an exhaust port (EX) of the first shift valve 22. There is an orifice and a check valve mounted on an oil passage extending between the third switching circuit 22i of the first shift valve 22 and the third switching circuit 23i of the second shift valve 23.

The second shift valve 23 is a switching valve for selectively establishing an oil passage and incorporates, in its valve body, a first spool 23a, a second spool 23b, a spring 23c, a first hydraulic chamber 23d, a second hydraulic chamber 23e, and a third hydraulic chamber 23f. The first spool 23a is arranged to be slidable within the valve body (not illustrated). The second spool 23b is arranged at an opposite side to the first spool 23a relative to the spring 23c in the valve body (not illustrated) and is slidably positioned in the valve body. The spring 23c, which is arranged in the second hydraulic chamber 23e, biases the first spool 23a towards the first hydraulic chamber 23d and the second spool 23b towards the third hydraulic chamber 23f. When the second shift valve 23 is inputted with a signal pressure of the second on-off solenoid valve S2, the first hydraulic chamber 23d is actuated so as to bias the first spool 23a towards the third hydraulic chamber 23f. When the second shift valve 23 is inputted with the pressure R of the pressure R port of the manual valve 21, the second hydraulic chamber 23e is actuated so as to bias the first spool 23a towards the first hydraulic chamber 23d and the second spool 23b towards the third hydraulic chamber 23f. When the second shift valve 23 is inputted with an hydraulic pressure via the sixth switching circuit 231 of the second shift valve 23, the third hydraulic chamber 23f is actuated so as to bias the second spool 23b towards the first hydraulic chamber 23d. In case where a force level of the hydraulic pressure applied by the first hydraulic chamber 23d is higher than the sum of the biasing force of the spring 23c and the hydraulic pressure applied by the second hydraulic chamber 23e or is higher than the sum of the biasing force of the spring 23c and the hydraulic pressure applied by the third hydraulic chamber 23f, the first spool 23a is slidably moved towards the third hydraulic chamber 23f (“x” in FIG. 4). In an opposite case thereto, the first spool 23a is slidably moved towards the first hydraulic chamber 23d (“∘”). The first spool 23a of the second shift valve 23 is formed with a first switching circuit 23g. Because of this structure having the first switching circuit 23g, when the first spool 23a is positioned as denoted with “x” in FIG. 4, a fluid communication is established among the supply port of the first control valve unit SL1, the D-N accumulator 25, the first switching circuit 22g of the first shift valve 22 and the fourth switching circuit 24h of the third shift valve 24. On the other hand, when the first spool 23a is positioned as denoted with “∘” in FIG. 4, a fluid communication is established among the supply port of the first control valve unit SL1, the D-N accumulator 25 and the pressure D port of the manual valve 21. The second shift valve 23 further includes a second switching circuit 23h. Because of this structure having the second switching circuit 23h, when the first spool 23a is positioned as denoted with “∘” in FIG. 4, a fluid communication is established among the first shuttle valve SB1, the first switching circuit 22g of the first shift valve 22 and a fourth switching circuit 24h of the third shift valve 24. On the other hand, when the first spool 23a is positioned as denoted with “x” in FIG. 4, the first shuttle valve SB1 fluidly communicates with an exhaust port (EX) of the second shift valve 23. The second shift valve 23 still further includes the third switching circuit 23i. Because of this structure having the third switching circuit 23i, when the first spool 23a is positioned as denoted with “x” in FIG. 4, the supply port of the third control valve unit SL3 fluidly communicates with the first switching circuit 24e of the third shift valve 24. On the other hand, when the first spool 23a is positioned as denoted with “∘” in FIG. 4, the supply port of the third control valve unit SL3 fluidly communicates with the third switching circuit 22i of the first shift valve 22. The second shift valve 23 still further includes a fourth switching circuit 23j. Because of this structure having the fourth switching circuit 23j, when the first spool 23a is positioned as denoted with “∘” in FIG. 4, a fluid communication is established among the second switching circuit 22h of the first shift valve 22, the fifth switching circuit 24i of the third shift valve 24 and the supply port of the fourth control valve unit SL4. On the other hand, when the first spool 23a is positioned as denoted with “x” in FIG. 4, the second switching circuit 22h of the first shift valve 22 fluidly communicates with an exhaust port (EX) of the second shift valve 23. The second shift valve 23 still further includes the fifth switching circuit 23k. Because of this structure having the fifth switching circuit 23k, when the first spool 23a is positioned as denoted with “x” in FIG. 4, a fluid communication is established among the sixth switching circuit 221 of the first shift valve 22, the second shuttle valve SB2 and the pressure D port of the manual valve 21. On the other hand, when the first spool 23a is positioned as denoted with “∘” in FIG. 4, a fluid communication is established among the sixth switching circuit 221 of the first shift valve 22, the second shuttle valve SB2 and an exhaust port (EX) of the second shift valve 23. The second shift valve 23 still further includes the sixth switching circuit 231. Because of this structure having the sixth switching circuit 231, when the first spool 23a is positioned as denoted with “∘” in FIG. 4, a fluid communication is established among the third hydraulic chamber 23f of the second shift valve 23, the third shuttle valve SB3 and the fourth switching circuit 22j of the first shift valve 22. On the other hand, when the first spool 23a is positioned as denoted with “x” in FIG. 4, a fluid communication is established among the third hydraulic chamber 23f of the second shift valve 23, the third shuttle valve SB3 and an exhaust port (EX) of the second shift valve 23. There is an orifice and check valve mounted on an oil passage extending between the third switching circuit 23g of the second shift valve 23 and the pressure D port of the manual valve 21.

The third shift valve 24 is a switching valve for selectively establishing an oil passage and incorporates, in its valve body, a spool 24a, a spring 24b, a first hydraulic chamber 24c and a second hydraulic chamber 24d. The spool 24a is arranged to be slidable within the valve body (not illustrated). The spring 24b is arranged in the second hydraulic chamber 24d and biases the spool 24a towards the first hydraulic chamber 24c. When the third shift valve 24 is inputted with a signal pressure of the third on-off solenoid valve S3, the first hydraulic chamber 24c is actuated so as to bias the spool 24a towards the second hydraulic chamber 24d. The second hydraulic chamber 24d fluidly communicates with an exhaust port (exhaust circuit; EX). In case where a force level of the hydraulic pressure applied by the first hydraulic chamber 24c is higher than the biasing force of the spring 24b, the spool 24a is slidably moved towards the second hydraulic chamber 24d (“x” in FIG. 4). In an opposite case thereto, the spool 24a is slidably moved towards the first hydraulic chamber 24c (“∘” in FIG. 4). The spool 24a of the third shift valve 24 is formed with the first switching circuit 24e. Because of this structure having the first switching circuit 24e, when the spool 24a is positioned as denoted with “x” in FIG. 4, the third switching circuit 23i of the second shift valve 23 fluidly communicates with the pressure PL port. On the other hand, when the spool 24a is positioned as denoted with “∘” in FIG. 4, the third switching circuit 23i of the second shift valve 23 fluidly communicates with an exhaust port (EX) of the third shift valve 24. The third shift valve 24 further includes the second switching circuit 24f. Because of this structure having the second switching circuit 24f, when the spool 24a is positioned as denoted with “x” in FIG. 4, the supply port of the LU control valve unit SLU fluidly communicates with an exhaust port (EX) of the third shift valve 24. On the other hand, when the spool 24a is positioned as denoted with “∘” in FIG. 4, the supply port of the LU control valve unit SLU fluidly communicates with the pressure PL port. The third shift valve 24 still further includes the third switching circuit 24g. Because of this structure having the third switching circuit 24g, when the spool 24a is positioned as denoted with “x” in FIG. 4, a fluid communication is established among the drain port of the third control valve unit SL3, the N-R accumulator 27 and the second shuttle valve SB2. On the other hand, when the spool 24a is positioned as denoted with “∘” in FIG. 4, the drain port of the third control valve unit SL3, the N-R accumulator 27 and an exhaust port (EX) of the third shift valve 24. The third shift valve 24 still further includes the fourth switching circuit 24h. Because of this structure having the fourth switching circuit 24h, when the spool 24a is positioned as denoted with “x” in FIG. 4, a fluid communication is established among the drain port of the first control valve unit SL1, the N-D accumulator 26, the first switching circuit 23g of the second shift valve 23 and the second switching circuit 23h. On the other hand, when the spool 24a is positioned as denoted with “∘” in FIG. 4, a fluid communication is established among the drain port of the first control valve unit SL1, the N-D accumulator 26 and an exhaust port (EX) of the third shift valve 24. The third shift valve 24 still further includes the fifth switching circuit 24i. Because of this structure having the fifth switching circuit 24i, when the spool 24a is positioned as denoted with “∘” in FIG. 4, a fluid communication is established among the fourth switching circuit 23j of the second shift valve 23, the supply port of the fourth control valve unit SL4 and the pressure D port of the manual valve 21. On the other hand, when the spool 24a is positioned as denoted with “x” in FIG. 4, a fluid communication is established among the fourth switching circuit 23j of the second shift valve 23, the supply port of the fourth control valve unit SL4 and an exhaust port (EX) of the third shift valve 24. The third shift valve 24 still further includes the sixth switching circuit 24j. Because of this structure having the sixth switching circuit 24j, when the spool 24a is positioned as denoted with “x” in FIG. 4, the second frictional brake B2S fluidly communicates with the first shuttle valve SB1. On the other hand, when the spool 24a is positioned as denoted with “∘” in FIG. 4, the second frictional brake B2S fluidly communicates with the pressure R port of the manual valve 21. There is an orifice and a check valve mounted on an oil passage extending between the third switching circuit 24g of the third shift valve 24 and the drain port of the third control valve unit SL3. There is an orifice and a check valve mounted on an oil passage extending between the fourth switching circuit 24h of the third shift valve 24 and the drain port of the first control valve unit SL1. There is an orifice and a check valve mounted on an oil passage extending between the sixth switching circuit 24j of the third shift valve 24 and the first shuttle valve SB1. There is an orifice and a check valve mounted on an oil passage extending between the sixth switching circuit 24j of the third shift valve 24 and the second frictional brake B2S.

The first on-off solenoid valve S1 switches an operated condition of the first spool 22a of the first shift valve 22 in response to energizing or de-energizing thereto. The first on-off solenoid valve S1 is a normally high-type solenoid valve (NH), which supplies a signal pressure to the first shift valve 22 in the de-energized state and does not supply in the energized state.

The second on-off solenoid valve S2 switches an operated condition of the first spool 23a of the second shift valve 23 in response to energizing or de-energizing thereto. The second on-off solenoid valve S2 is a normally high-type solenoid valve (NH), which supplies a signal pressure to the second shift valve 23 in the de-energized state and does not supply in the energized state.

The third on-off solenoid valve S3 switches an operated condition of the spool 24a of the third shift valve 24 in response to energizing or de-energizing thereto. The third on-off solenoid valve S3 is a normally high-type solenoid valve (NH), which supplies a signal pressure to the third shift valve 24 in the de-energized state and does not supply in the energized state.

The D-N accumulator 25 is mounted on an oil passage extending between the supply port of the first control valve unit SL1 and the first switching circuit 23g of the second shift valve 23 and is actuated to absorb hydraulic shock that may occur at a time of a shift operation from the D range to the N range.

The N-D accumulator 26 is mounted on an oil passage extending between the drain port of the first control valve unit SL1 and the fourth switching circuit 24h of the third shift valve 24 and is actuated to absorb hydraulic shock that may occur at a time of a shift operation from the N range to the D range.

The N-R accumulator 27 is mounted on an oil passage extending between the drain port of the third control valve unit SL3 and the third switching circuit 24g of the third shift valve 24 and is actuated to absorb hydraulic shock that may occur at a time of a shift operation from the N range to the R range.

The first hydraulic switch SW1 is a hydraulic switch that is turned on when being supplied with the output pressure of the first control valve unit SL1.

The second hydraulic switch SW2 is a hydraulic switch that is turned on when being supplied with the output pressure of the second control valve unit SL2.

The third hydraulic switch SW3 is a hydraulic switch that is turned on when being supplied with the output pressure of the third control valve unit SL3.

The fourth hydraulic switch SW4 is a hydraulic switch that is turned on when being supplied with the output pressure of the fourth control valve unit SL4.

The fifth hydraulic switch SW5 is a hydraulic switch that is turned on when being supplied with the output pressure of the fifth control valve unit SL5.

The LU relay valve 28 is a switching valve that switches an oil passage when being supplied with the output pressure of the LU control valve unit SLU.

The first shuttle valve SB1 can be supplied with the output pressure (pressure D) of the second switching circuit 23h of the second shift valve 23 and the pressure R of the manual valve 21. When the output pressure (pressure D) of the second switching circuit 23h of the second shift valve 23 is higher than the pressure R, the sixth switching circuit 24j of the third shift valve 24 is supplied with the output pressure (pressure D) of the second switching circuit 23h. In an opposite case thereto, the sixth switching circuit 24j of the third shift valve 24 is supplied with the pressure R.

The second shuttle valve SB2 can be supplied with the output pressure (pressure D) of the fifth switching circuit 23k of the second shift valve 23 and the pressure R of the manual valve 21. When the output pressure (pressure D) of the fifth switching circuit 23k of the second shift valve 23 is higher than the pressure R, the third switching circuit 24g of the third shift valve 24 is supplied with the output pressure (pressure D) of the fifth switching circuit 23k. In an opposite case thereto, the third switching circuit 24g of the third shift valve 24 is supplied with the pressure R.

The third shuttle valve SB3 can be supplied with the output pressure (pressure D) of the sixth switching circuit 231 of the second shift valve 23 and the pressure R of the manual valve 21. When the output pressure (pressure D) of the sixth switching circuit 231 of the second shift valve 23 is higher than the pressure R, the second frictional brake B2L is supplied with the output pressure (pressure D) of the sixth switching circuit 231 of the second shift valve 23. In an opposite case thereto, the second frictional brake B2L is supplied with the pressure R.

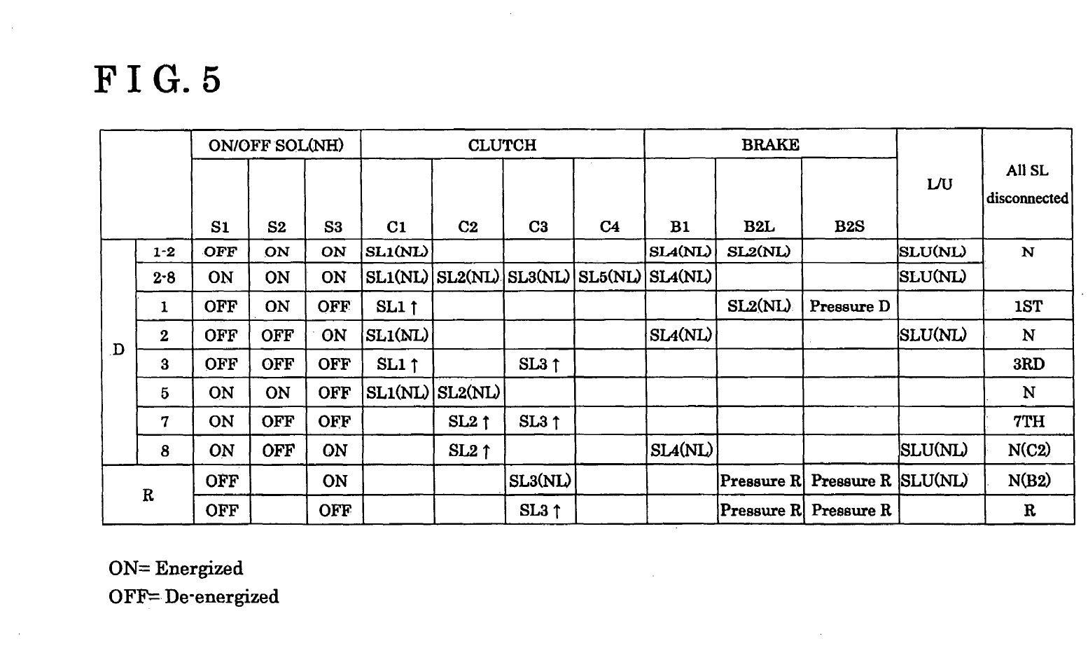

Described blow is a shift pattern selected in response to a control state of the hydraulic pressure control unit according to the first embodiment of the present invention. FIG. 5 is a table for explaining a shift pattern at each driving range selected in accordance with a control state of the hydraulic pressure control unit according to the first embodiment.

In FIG. 5, the D range is denoted with “D”, the R range is denoted with “R”. There are forward shift stages inscribed at the right side of the “D” column. At the columns of the on-off solenoid valves (NH) S1, S2 and S3, “On” represents that the NH-type on-off solenoid valve is in the energized state, and “Off” represents that the NH-type on-off solenoid valve is in the de-energized state.

In each column for the frictional engagement element, “SL1 (NL)” represents that the corresponding frictional engagement element can be controlled by the NL-type first control valve unit SL1. “SL2 (NL)” represents that the corresponding frictional engagement element can be controlled by the NL-type second control valve unit SL2. “SL3 (NL)” represents that the corresponding frictional engagement element can be controlled by the NL-type third control valve unit SL3. “SL4 (NL)” represents that the corresponding frictional engagement element can be controlled by the NL-type fourth control valve unit SL4. “SL5 (NL)” represents that the corresponding frictional engagement element can be controlled by the NL-type fifth control valve unit SL5. “SLU (NL)” represents that the corresponding frictional engagement element can be controlled by the NL-type LU control valve unit SLU. “SL1↑”, “SL2↑” and “SL3↑” each represents that the corresponding frictional engagement element can be frictionally engaged by the line pressure from the corresponding control valve unit.

“All SL Disconnected” represents a state where all of the solenoid valves SL1, SL2, SL3, SL4 and SLU are electrically disconnected (electrically fail). “N” represents that all of the engaging elements are in the disengaged states and are positioned neutrally. “N (C2)” represents that a neutral shift stage is established in the transmission with only the second frictional clutch C2 engaged. “N (B2)” represents that a neutral shift stage is established in the transmission with only the second frictional brakes B2S and B2L engaged.

In the first embodiment, the 8-speed automatic transmission 1 is achieved only by adding the fifth control valve unit SL5 and without any changes to a basic hydraulic circuit of the hydraulic pressure control unit 3, which leads to reduction in manufacturing cost and development hours. Further, because there is no fail-safe valve mounted in the hydraulic pressure control unit 3, there is no possibility for a double engagement to occur during a fixed shift stage mode due to a primary failure of the fail-safe valve. Therefore, even in the event of a failure during a shift mode, a safe driving of a vehicle is assured by changing the shift mode to the fixed shift stage mode.

Further, as described above, the first shift valve 22 includes the second switching circuit 22h, and the second shift valve 23 includes the fourth switching circuit 23j. Therefore, only when all the on-off solenoid valves S1, S2 and S3 are electrically energized, the fifth control valve unit SL5 is supplied with the output pressure (pressure D) of the fifth switching circuit 24i of the third shift valve 24 via the second switching circuit 22h of the first shift valve 22 and the fourth switching circuit 23j of the second shift valve 23. Therefore, the oil passage, which extends to the fifth control valve unit SL5 from the fifth switching circuit 24i of the third shift valve 24, does not have to bypass the first shift valve 22 and the second shift valve 23 and is firmly wire-connected between the fifth control valve unit SL5 and the fifth switching circuit 24i of the third shift valve 24.

### Second Embodiment

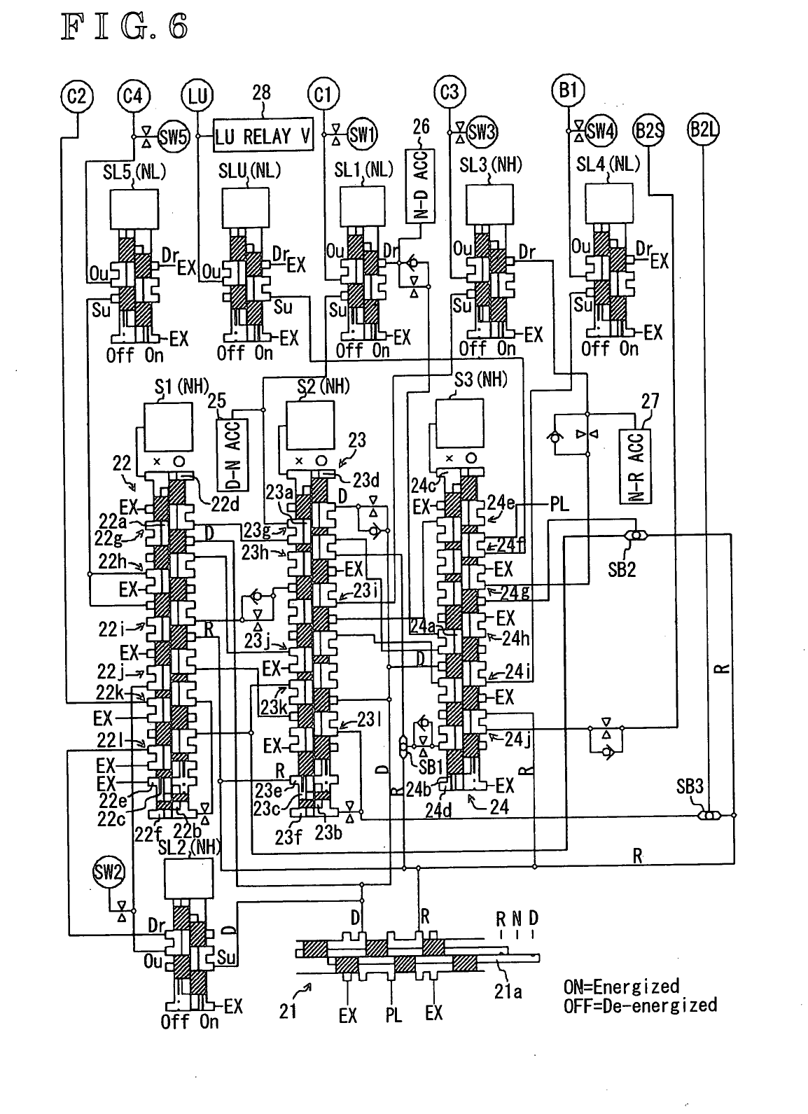

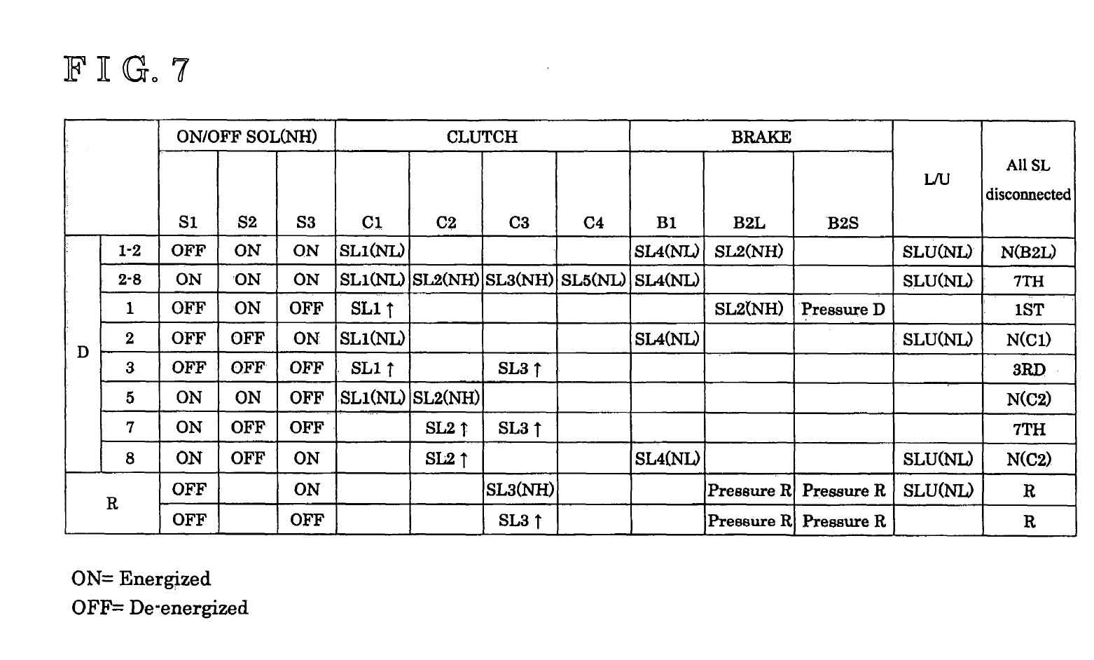

Described below is a hydraulic pressure control apparatus for an automatic transmission according to a second embodiment of the present invention, with reference to the attached drawings. FIG. 6 is a hydraulic circuit diagram partially schematically illustrating a structure of a hydraulic pressure control unit according to the second embodiment of the present invention. FIG. 7 is a table for explaining a shift pattern at each driving range selected in accordance with a control state of the hydraulic pressure control unit according to the second embodiment.

The configuration of the oil passage of the second embodiment is substantially the same as that of the first embodiment. However, the second and third control valve units SL2 and SL 3 herein are not the normally low-type control valve units (NL) but the normally high-type control valve units (NH) on the premise that a normally high-type control valve unit can be developed so as to be mounted on the apparatus.

In the second embodiment, the same effect as that of the first embodiment can be exerted, and the NH-type control valve unit contributes to enhance a driving performance of a vehicle. That is, as illustrated in FIG. 7, even when electric disconnection occurs for all of the control valve units in the situation where the on-off solenoid valve S1 is in a de-energized state, the on-off solenoid valve S2 is in an energized state and the on-off solenoid valve S3 is in a de-energized state, the vehicle can start at the 1st shift stage. Further, even when electric disconnection occurs for all of the control valve units in the situation where the on-off solenoid valves S1, S2 and S3 are all in the energized state, the vehicle can drive at the 5th shift stage. Still further, the change from the NL-type to the NH-type for the control valve unit, does not cause any changes in the hydraulic circuit of the hydraulic pressure control unit 3, and does not require any other additional valves against an off-failure of the control valve unit.

### Third Embodiment

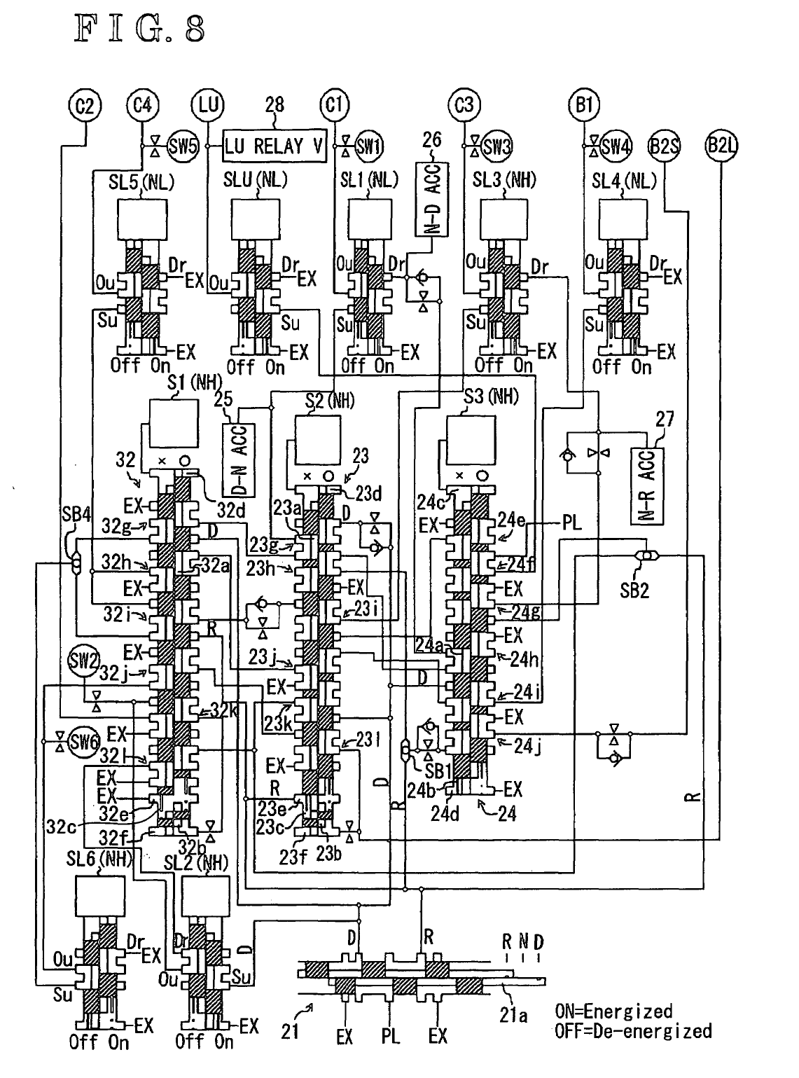

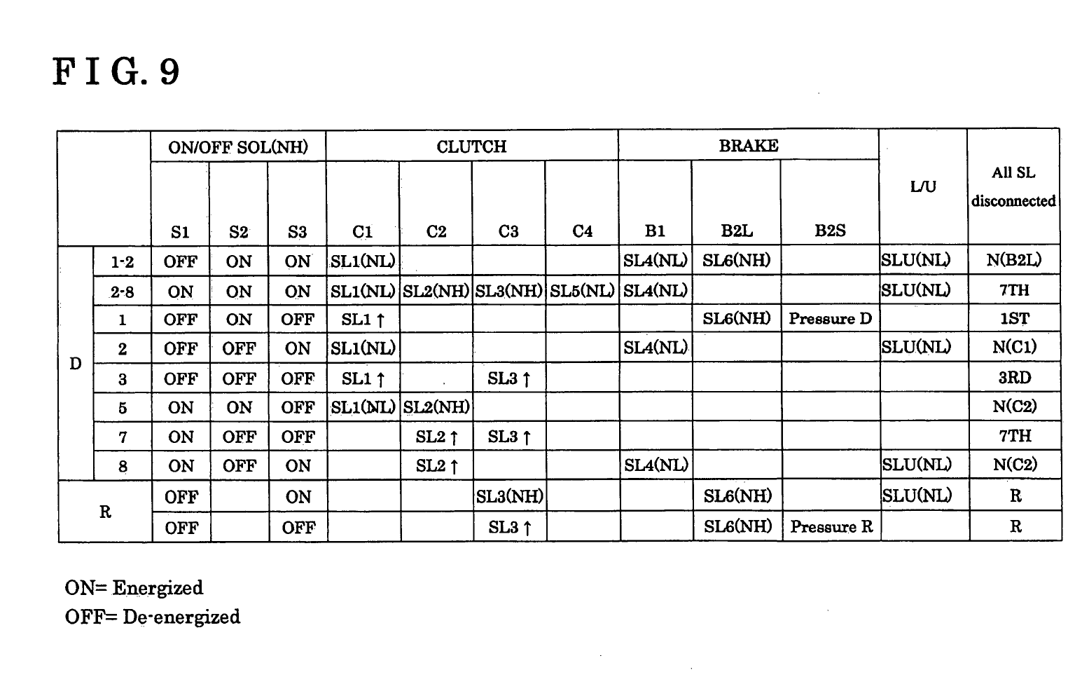

Described below is a hydraulic pressure control apparatus for an automatic transmission according to a third embodiment of the present invention, with reference to the attached drawings. FIG. 8 is a hydraulic circuit diagram partially schematically illustrating a structure of a hydraulic pressure control unit according to the third embodiment of the present invention. FIG. 9 is a table for explaining a shift pattern at each driving range selected in accordance with a control state of the hydraulic pressure control unit according to the third embodiment.

In the second embodiment, the second control valve unit SL2 is shared by the second frictional clutch C2 and the second frictional brake B2. In the third embodiment, however, the second control valve unit SL2 is exclusively used for the second frictional clutch C2, and a sixth control valve unit SL6 (additional control valve) is added as an exclusive unit for the second frictional brake B2. With the addition of the sixth control valve unit SL6, the use of the third shuttle valve (SB3 in FIG. 6 of the second embodiment) for the second frictional brake B2L is avoided, therefore but a fourth shuttle valve SB4 is required to selectively supply the pressure D or the pressure R to the sixth control valve unit SL6. Further, in the third embodiment, a first shift valve 32 is provided with a fourth switching circuit 32j, which prohibits the flow of the output pressure of the second control valve unit SL2 from the fourth switching circuit (22j in FIG. 6) of the first shift valve (22 in FIG. 6) to the sixth switching circuit (231 in FIG. 6 of the second embodiment) of the second shift valve (23 in FIG. 6 of the second embodiment). The fourth switching circuit 32j allows the supply of the output pressure of the sixth control valve unit SL6 to the sixth switching circuit 231 of the second shift valve 23. Moreover, in the third embodiment, the sixth switching circuit (24j in FIG. 6) of the third shift valve (24 in FIG. 6 of the second embodiment) is no longer connected, via its inlet port, to the pressure R port of the manual valve (21 in FIG. 6 of the second embodiment). The inlet port of the sixth switching circuit 24j of the third shift valve 24 of the third embodiment communicates with an exhaust circuit (EX). Described below are main structures that are different from the second embodiment.

The sixth control valve unit (control valve) SL6 is a control valve unit for the second frictional brake B2L and is integrated with a linear solenoid valve and a spool valve. The sixth control valve unit SL6 can be structured with a linear solenoid valve and a spool valve, which are mechanically isolated from each other. The spool valve of sixth control valve unit SL6 is selectively movable in response to an amount of electric power supplied to the linear solenoid valve of the sixth control valve unit SL6. The spool valve of the sixth control valve unit SL6 is formed with a supply port through which an output pressure (pressure D or R) of the fourth shuttle valve SB4 is introduced. In the sixth control valve unit SL6, a control hydraulic pressure is generated in response to an amount of electric power supplied to the linear solenoid valve of the sixth control valve unit SL6. The control hydraulic pressure is generated from the output pressure (pressure D or R) of the fourth shuttle valve SB4, which is introduced to the spool valve the sixth control valve unit SL6. The control hydraulic pressure is outputted via an output port of the spool valve. A drain port of the sixth control valve unit SL6 fluidly communicates with an exhaust circuit (EX). The output pressure (pressure SL6) of the sixth control valve unit SL6 is supplied to a sixth hydraulic switch SW6. The output pressure (pressure C2) of the sixth control valve unit SL6 is further supplied to the second frictional brake B2L via the fourth switching circuit 32j of the first shift valve 32 and the sixth switching circuit 231 of the second shift valve 23 in the situation where the first spool 32a of the first shift valve 32 is positioned as illustrated with “x” in FIG. 8 and the first spool 23a of the second shift valve 23 is positioned as illustrated in “∘” in FIG. 8. The sixth control valve unit SL6 is a normally high-type valve unit (NH), which outputs the pressure C2 at the maximum level in the de-energized state and decrementally outputs the pressure C2 in response to an increase in the amount of electric power supplied to the linear solenoid thereof in the energized state. The output port of the sixth control valve unit SL6 fluidly communicates with the supply port thereof in the de-energized state.

The first shift valve 32 is a switching valve for selectively establishing an oil passage and incorporates, in its valve body, a first spool 32a, a second spool 32b, a spring 32c, a first hydraulic chamber 32d, a second hydraulic chamber 32e, and a third hydraulic chamber 32f. The first spool 32a is arranged to be slidable within the valve body (not illustrated). The second spool 32b is arranged at an opposite side to the first spool 32a relative to the spring 32c in the valve body (not illustrated) and is slidably positioned in the valve body. The spring 32c, which is arranged in the second hydraulic chamber 32e, biases the first spool 32a towards the first hydraulic chamber 32d and the second spool 32b towards the third hydraulic chamber 32f. When the first shift valve 32 is inputted with a signal pressure of the first on-off solenoid valve S1, the first hydraulic chamber 32d is actuated so as to bias the first spool 32a towards the third hydraulic chamber 32f. The second hydraulic chamber 32e is a hydraulic chamber communicating with an exhaust port (exhaust circuit; EX). When an hydraulic pressure (pressure C2) for the second frictional clutch C2 is introduced to the first shift valve 32, the third hydraulic chamber 32f is actuated so as to bias the second spool 32b towards the first hydraulic chamber 32d. In case where a force level of the hydraulic pressure applied by the first hydraulic chamber 32d is higher than the sum of the biasing force of the spring 32c and the hydraulic pressure applied by the third hydraulic chamber 32f, the first spool 32a is slidably moved towards the third hydraulic chamber 32f(“x” in FIG. 8). In an opposite case thereto, the first spool 32a is slidably moved towards the first hydraulic chamber 32d (“∘”). The first spool 32a of the first shift valve 32 is formed with a first switching circuit 32g. Because of this structure having the first switching circuit 32g, when the first spool 32a is positioned as denoted with “x” in FIG. 8, a fluid communication is established among the first switching circuit 23g and the second switching circuit 23h of the second shift valve 23, and the pressure D port of the manual valve 21. On the other hand, when the first spool 32a is positioned as denoted with “∘” in FIG. 8, a fluid communication is established among the first switching circuit 23g and the second switching circuit 23h of the second shift valve 23, and an exhaust port (EX) of the first shift valve 32. The first shift valve 32 further includes the second switching circuit 32h. Because of this structure having the second switching circuit 32h, when the first spool 32a is positioned as denoted with “x” in FIG. 8, the supply port of the fifth control valve unit SL5 fluidly communicates with an exhaust port (EX) of the first shift valve 32. On the other hand, when the first spool 32a is positioned as denoted with “∘” in FIG. 8, the supply port of the fifth control valve unit SL5 fluidly communicates with the fourth switching circuit 23j of the second shift valve 23. The first shift valve 32 still further includes the third switching circuit 32i. Because of this structure having the third switching circuit 32i, when the first spool 32a is positioned as denoted with “x” in FIG. 8, the third switching circuit 23i of the second shift valve 23 fluidly communicates with the pressure R port of the manual valve 21. On the other hand, when the first spool 32a is positioned as denoted with “∘” in FIG. 8, a fluid communication is established among the third switching circuit 23i of the second shift valve 23, the second switching circuit 32h of the first shift valve 32 and the supply port of the fifth control valve unit SL5. The first shift valve 32 still further includes a fourth switching circuit 32j. Because of this structure having the fourth switching circuit 32j, when the first spool 32a is positioned as denoted with “x” in FIG. 8, a fluid communication is established among the sixth switching circuit 231 of the second shift valve 23, the output port of the sixth control valve unit SL6 and the sixth hydraulic switch SW6. On the other hand, when the first spool 32a is positioned as denoted with “∘” in FIG. 8, the sixth switching circuit 231 of the second shift valve 23 fluidly communicates with an exhaust port (EX) of the first shift valve 32. The first shift valve 32 still further includes the fifth switching circuit 32k. Because of this structure having the fifth switching circuit 32k, when the first spool 32a is positioned as denoted with “∘” in FIG. 8, a fluid communication is established among the second frictional clutch C2, the third hydraulic chamber 32f of the first shift valve 32, the output port of the second control valve unit SL2 and the hydraulic switch SW2. On the other hand, when the first spool 32a is positioned as denoted with “x” in FIG. 8, a fluid communication is established among the second frictional clutch C2, the third hydraulic chamber 32f and the exhaust port (EX) of the first shift valve 32. The first shift valve 32 still further includes the sixth switching circuit 321. Because of this structure having the sixth switching circuit 321, when the first spool 32a is positioned as denoted with “∘” in FIG. 8, the drain port of the second control valve unit SL2 fluidly communicates with the fifth switching circuit 23 of the second shift valve 23. On the other hand, when the first spool 32a is positioned as denoted with “x” in FIG. 8, the drain port of the second control valve unit SL2 fluidly communicates with an exhaust port (EX) of the first shift valve 32. There is an orifice and a check valve mounted on an oil passage extending between the third switching circuit 32i of the first shift valve 32 and the third switching circuit 23i of the second shift valve 23.

The fourth shuttle valve SB4 can be supplied with the pressure D and the pressure R of the manual valve 21. When the pressure D is higher than the pressure R, the supply port of the sixth control valve unit SL6 is supplied with the pressure D. In an opposite case thereto, the supply port of the sixth control valve unit SL6 is supplied with the pressure R.

The sixth hydraulic switch SW6 is a hydraulic switch that is turned on when being supplied with the output pressure of the sixth control valve unit SL6.

In the third embodiment, the same effect as the first and second embodiment can be effected.

### Fourth Embodiment

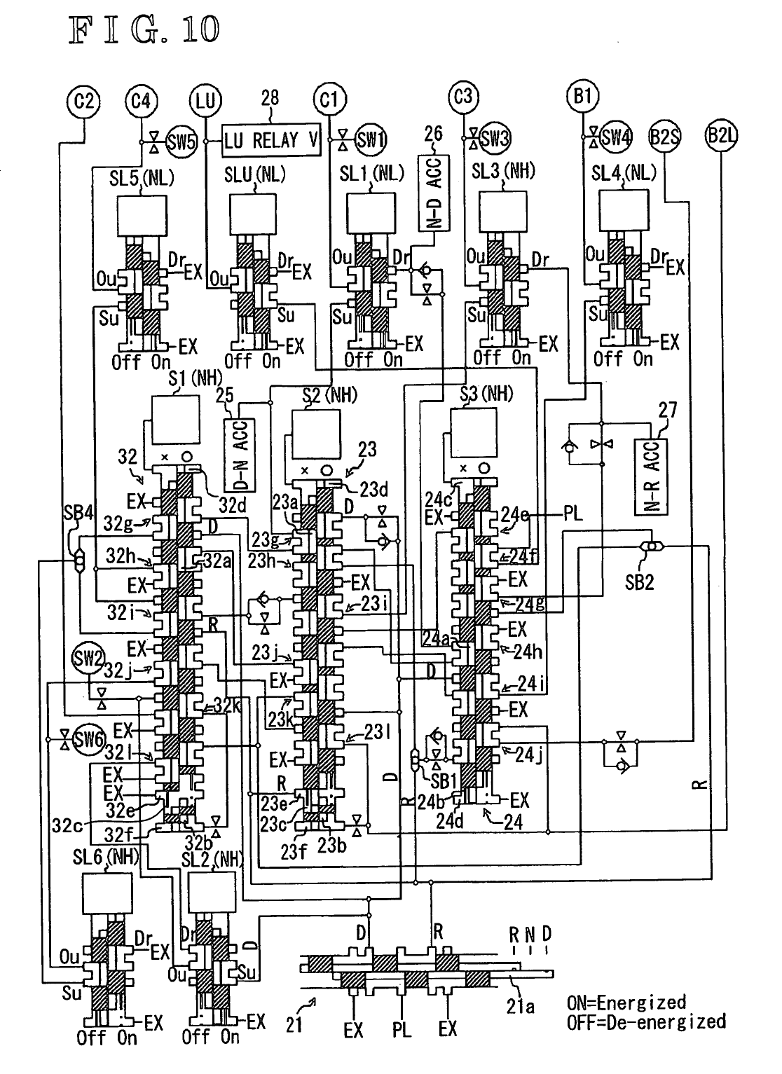

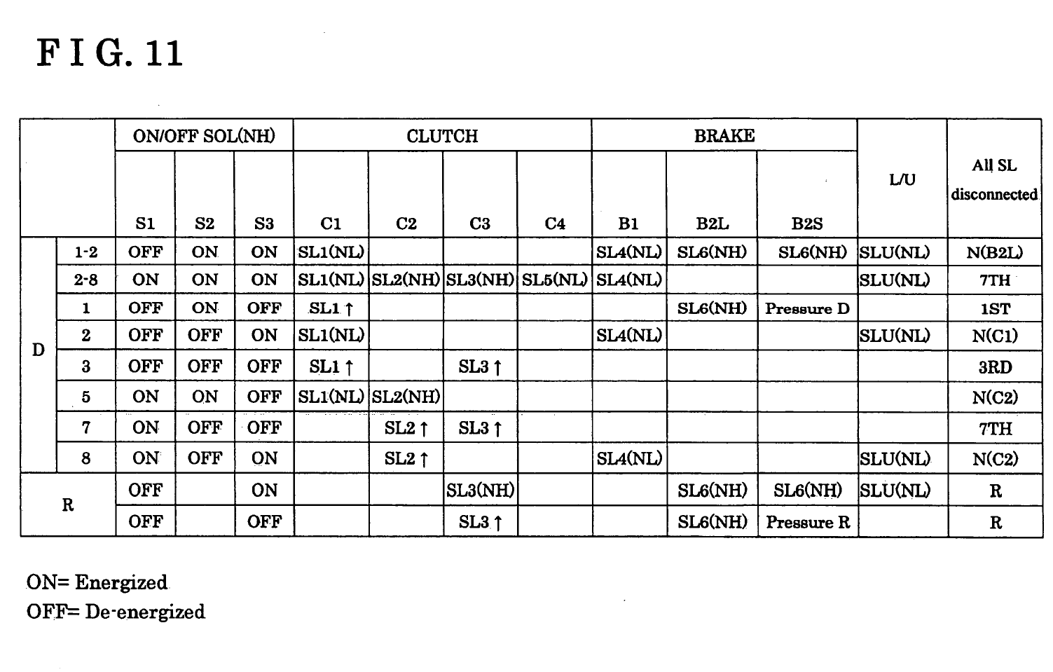

Described below is a hydraulic pressure control apparatus for an automatic transmission according to a fourth embodiment of the present invention, with reference to the attached drawings. FIG. 10 is a hydraulic circuit diagram partially schematically illustrating a structure of a hydraulic pressure control unit according to the fourth embodiment of the present invention. FIG. 11 is a table for explaining a shift pattern at each driving range selected in accordance with a control state of the hydraulic pressure control unit according to the fourth embodiment.

In the third embodiment, the input port of the sixth switching circuit (24j in FIG. 8) of the third shift valve (24 in FIG. 8) fluidly communicates with the exhaust port of the third shift valve 24. In the fourth embodiment, however, a sixth switching circuit 24j of a third shift valve 24 is mounted on an oil passage extending between the sixth switching circuit 231 of the second shift valve 23 and the second frictional brake B2L. The other configuration of the hydraulic circuit and the apparatus of the fourth embodiment is the same as that of the third embodiment.

In the fourth embodiment, the same effect as the first and second embodiments is yielded. As illustrated in FIG. 11, with the on-off solenoid valve S1 in the de-energized state, the on-off solenoid valve S2 in the energized state and the on-off solenoid valve S3 in the energized state during the D range being selected, the second frictional brake B2S is also supplied with the pressure C2 and is controlled for engagement. Therefore, an amount of torque is assured reliably. This is also applied to the case with the on-off solenoid valve S1 in the de-energized state, the on-off solenoid valve S2 in the energized or de-energized state and the on-off solenoid valve S3 in the energized state during the R range being selected. The second hydraulic chamber 23e is supplied with the pressure R so that the first spool 23a of the second shift valve 23 is positioned at the side of “∘” in FIG. 10 regardless if the on-off solenoid valve S2 is in the energized or de-energized state.

### Fifth Embodiment

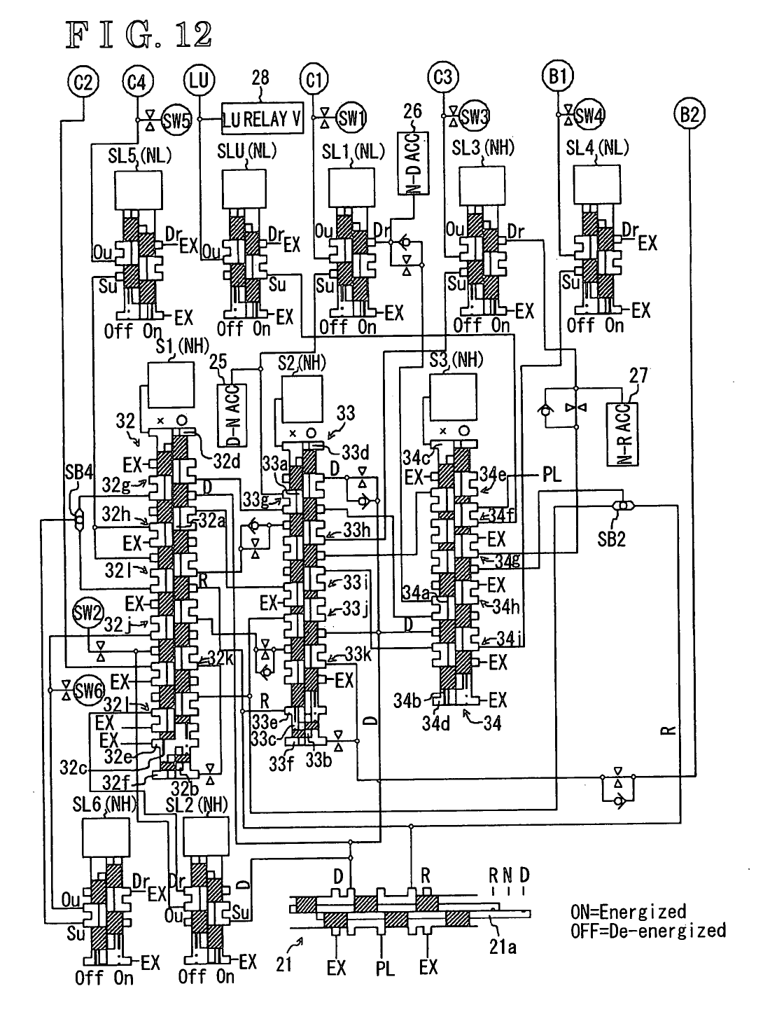

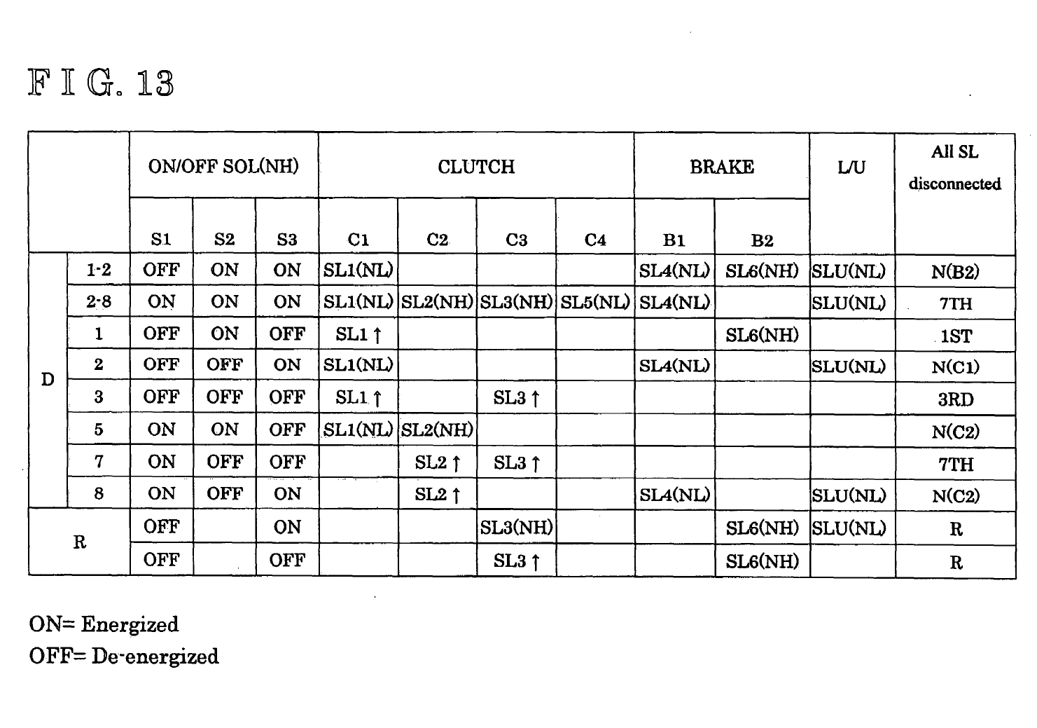

Described below is a hydraulic pressure control apparatus for an automatic transmission according to a fifth embodiment of the present invention, with reference to the attached drawings. FIG. 12 is a hydraulic circuit diagram partially schematically illustrating a structure of a hydraulic pressure control unit according to the fifth embodiment of the present invention. FIG. 13 is a table for explaining a shift pattern at each driving range selected in accordance with a control state of the hydraulic pressure control unit according to the fifth embodiment.

In the fourth embodiment, a piston chamber for the second frictional brake is structured with two chambers of B2S and B2L. In the fifth embodiment, the piston chamber thereof is a single chamber B2 (second frictional brake). Abolished in the fifth embodiment are: the second switching circuit (23h in FIG. 10 of the fourth embodiment) of the second shift valve (23 in FIG. 10); the sixth switching circuit (24j in FIG. 10) of the third shift valve (24 in FIG. 10); and the first shuttle valve (SB1 in FIG. 10), and the orifice and the check valve mounted on the oil passage between the first shuttle valve (SB 1 in FIG. 10) and the sixth switching circuit (24j in FIG. 10) of the third shift valve (24 in FIG. 10) is relocated onto an oil passage extending between the fourth switching circuit 32j of the first shift valve 32 and the fifth switching circuit 33k of the second shift valve 33. Described below are main structures that are different from the fourth embodiment.

The second shift valve 33 is a switching valve for selectively establishing an oil passage and incorporates, in its valve body, a first spool 33a, a second spool 33b, a spring 33c, a first hydraulic chamber 33d, a second hydraulic chamber 33e, and a third hydraulic chamber 33f. The first spool 33a is arranged to be slidable within the valve body (not illustrated). The second spool 33b is arranged at an opposite side to the first spool 33a relative to the spring 33c in the valve body (not illustrated) and is slidably positioned in the valve body. The spring 33c, which is arranged in the second hydraulic chamber 33e, biases the first spool 33a towards the first hydraulic chamber 33d and the second spool 33b towards the third hydraulic chamber 33f. When the second shift valve 33 is inputted with a signal pressure of the second on-off solenoid valve S2, the first hydraulic chamber 33d is actuated so as to bias the first spool 33a towards the third hydraulic chamber 33f. When the second shift valve 33 is inputted with the pressure R of the pressure R port of the manual valve 21, the second hydraulic chamber 33e is actuated so as to bias the first spool 33a towards the first hydraulic chamber 33d and the second spool 33b towards the third hydraulic chamber 33f. When the second shift valve 33 is inputted with an hydraulic pressure via the fifth switching circuit 33k of the second shift valve 33, the third hydraulic chamber 33f is actuated so as to bias the second spool 33b towards the first hydraulic chamber 33d. In case where a force level of the hydraulic pressure applied by the first hydraulic chamber 33d is higher than the sum of the biasing force of the spring 33c and the hydraulic pressure applied by the second hydraulic chamber 33e or is higher than the sum of the biasing force of the spring 33c and the hydraulic pressure applied by the third hydraulic chamber 33f, the first spool 33a is slidably moved towards the third hydraulic chamber 33f (“x” in FIG. 12). In an opposite case thereto, the first spool 33a is slidably moved towards the first hydraulic chamber 33d (“∘”). The first spool 33a of the second shift valve 33 is formed with a first switching circuit 33g. Because of this structure having the first switching circuit 33g, when the first spool 33a is positioned as denoted with “x” in FIG. 12, a fluid communication is established among the supply port of the first control valve unit SL1, the D-N accumulator 25, the first switching circuit 32g of the first shift valve 32 and the fourth switching circuit 34h of the third shift valve 34. On the other hand, when the first spool 33a is positioned as denoted with “∘” in FIG. 12, a fluid communication is established among the supply port of the first control valve unit SL1, the D-N accumulator 25 and the pressure D port of the manual valve 21. The second shift valve 33 further includes a second switching circuit 33h. Because of this structure having the second switching circuit 33h, when the first spool 33a is positioned as denoted with “x” in FIG. 12, the supply port of the third control valve unit SL3 fluidly communicates with the first switching circuit 34e of the third shift valve 34. On the other hand, when the first spool 33a is positioned as denoted with “∘” in FIG. 12, the supply port of the third control valve unit SL3 fluidly communicates with the third switching circuit 32i of the first shift valve 32. The second shift valve 33 still further includes a third switching circuit 33i. Because of this structure having the third switching circuit 33i, when the first spool 33a is positioned as denoted with “∘” in FIG. 12, a fluid communication is established among the second switching circuit 32h of the first shift valve 32, the fifth switching circuit 34i of the third shift valve 34 and the supply port of the fourth control valve unit SL4. On the other hand, when the first spool 33a is positioned as denoted with “x” in FIG. 12, the second switching circuit 32h of the first shift valve 32 fluidly communicates with an exhaust port (EX) of the second shift valve 33. The second shift valve 33 still further includes a fourth switching circuit 33j. Because of this structure having the fourth switching circuit 33j, when the first spool 33a is positioned as denoted with “x” in FIG. 12, a fluid communication is established among the sixth switching circuit 321 of the first shift valve 32, the second shuttle valve SB2 and the pressure D port of the manual valve 21. On the other hand, when the first spool 33a is positioned as denoted with “∘” in FIG. 12, a fluid communication is established among the sixth switching circuit 321 of the first shift valve 32, the second shuttle valve SB2 and an exhaust port (EX) of the second shift valve 33. The second shift valve 33 still further includes the fifth switching circuit 33k. Because of this structure having the fifth switching circuit 33k, when the first spool 33a is positioned as denoted with “x” in FIG. 12, a fluid communication is established among a third hydraulic chamber 33f of the second shift valve 33, the second frictional brake B2 and an exhaust port (EX) of the second shift valve 33. On the other hand, when the first spool 33a is positioned as denoted with “∘” in FIG. 12, a fluid communication is established among the third hydraulic chamber 33f of the second shift valve 33, the second frictional brake B2 and the fourth switching circuit 32j of the first shift valve 32. There are an orifice and a check valve mounted on an oil passage extending between the first switching circuit 33g of the second shift valve 33 and the pressure D port of the manual valve 21. There are an orifice and a check valve mounted on an oil passage extending between the fifth switching circuit 33k of the second shift valve 33 and the fourth switching circuit 32j of the first shift valve 32. There are an orifice and a check valve mounted on an oil passage extending between the fifth switching circuit 33k of the second shift valve 33 and the second frictional brake B2.

The third shift valve 34 is a switching valve for selectively establishing an oil passage and incorporates, in its valve body, a spool 34a, a spring 34b, a first hydraulic chamber 34c and a second hydraulic chamber 34d. The spool 34a is arranged to be slidable within the valve body (not illustrated). The spring 34b is arranged in the second hydraulic chamber 34d and biases the spool 34a towards the first hydraulic chamber 34c. When the third shift valve 34 is inputted with a signal pressure of the third on-off solenoid valve S3, the first hydraulic chamber 34c is actuated so as to bias the spool 34a towards the second hydraulic chamber 34d. The second hydraulic chamber 34d fluidly communicates with an exhaust port (exhaust circuit; EX). In case where a force level of the hydraulic pressure applied by the first hydraulic chamber 34c is higher than the biasing force of the spring 34b, the spool 34a is slidably moved towards the second hydraulic chamber 34d (“x” in FIG. 12). In an opposite case thereto, the spool 34a is slidably moved towards the first hydraulic chamber 34c (“∘” in FIG. 12). The spool 34a of the third shift valve 34 is formed with the first switching circuit 34e. Because of this structure having the first switching circuit 34e, when the spool 34a is positioned as denoted with “x” in FIG. 12, the second switching circuit 33h of the second shift valve 33 fluidly communicates with the pressure PL port. On the other hand, when the spool 34a is positioned as denoted with “∘” in FIG. 12, the second switching circuit 33h of the second shift valve 33 fluidly communicates with an exhaust port of the third shift valve 34. The third shift valve 34 further includes the second switching circuit 44f. Because of this structure having the second switching circuit 44f, when the spool 34a is positioned as denoted with “x” in FIG. 12, the supply port of the LU control valve unit SLU fluidly communicates with an exhaust port (EX) of the third shift valve 34. On the other hand, when the spool 34a is positioned as denoted with “∘” in FIG. 12, the supply port of the LU control valve unit SLU fluidly communicates with the pressure PL port. The third shift valve 34 still further includes the third switching circuit 34g. Because of this structure having the third switching circuit 34g, when the spool 34a is positioned as denoted with “x” in FIG. 12, a fluid communication is established among the drain port of the third control valve unit SL3, the N-R accumulator 27 and the second shuttle valve SB2. On the other hand, when the spool 34a is positioned as denoted with “∘” in FIG. 12, a fluid communication is established among the drain port of the third control valve unit SL3, the N-R accumulator 27 and an exhaust port (EX) of the third shift valve 34. The third shift valve 34 still further includes the fourth switching circuit 34h. Because of this structure having the fourth switching circuit 34h, when the spool 34a is positioned as denoted with “x” in FIG. 12, a fluid communication is established among the drain port of the first control valve unit SL1, the N-D accumulator 26, the first switching circuit 33g of the second shift valve 33 and the first switching circuit 32f of the first shift valve 32. On the other hand, when the spool 34a is positioned as denoted with “∘” in FIG. 12, a fluid communication is established among the drain port of the first control valve unit SL1, the N-D accumulator 26 and an exhaust port (EX) of the third shift valve 34. The third shift valve 34 still further includes the fifth switching circuit 34i. Because of this structure having the fifth switching circuit 34i, when the spool 34a is positioned as denoted with “∘” in FIG. 12, a fluid communication is established among the third switching circuit 33i of the second shift valve 33, the supply port of the fourth control valve unit SL4 and the pressure D port of the manual valve 21. On the other hand, when the spool 34a is positioned as denoted with “x” in FIG. 12, a fluid communication is established among the third switching circuit 33i of the second shift valve 33, the supply port of the fourth control valve unit SL4 and an exhaust port (EX) of the third shift valve 34. There is an orifice and a check valve mounted on an oil passage extending between the third switching circuit 34g of the third shift valve 34 and the drain port of the third control valve unit SL3. There is an orifice and a check valve mounted on an oil passage extending between the fourth switching circuit 34h of the third shift valve 34 and the drain port of the first control valve unit SL1. In the fifth embodiment, the same effects are yielded as the first, second, third and fourth embodiments.

### Sixth Embodiment

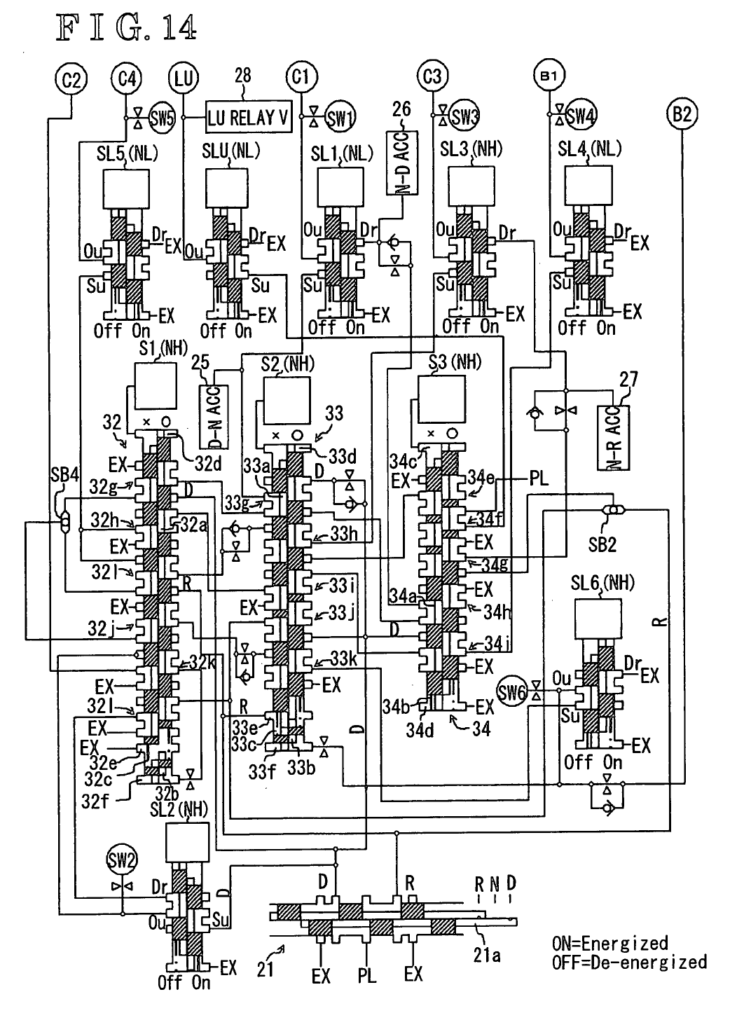

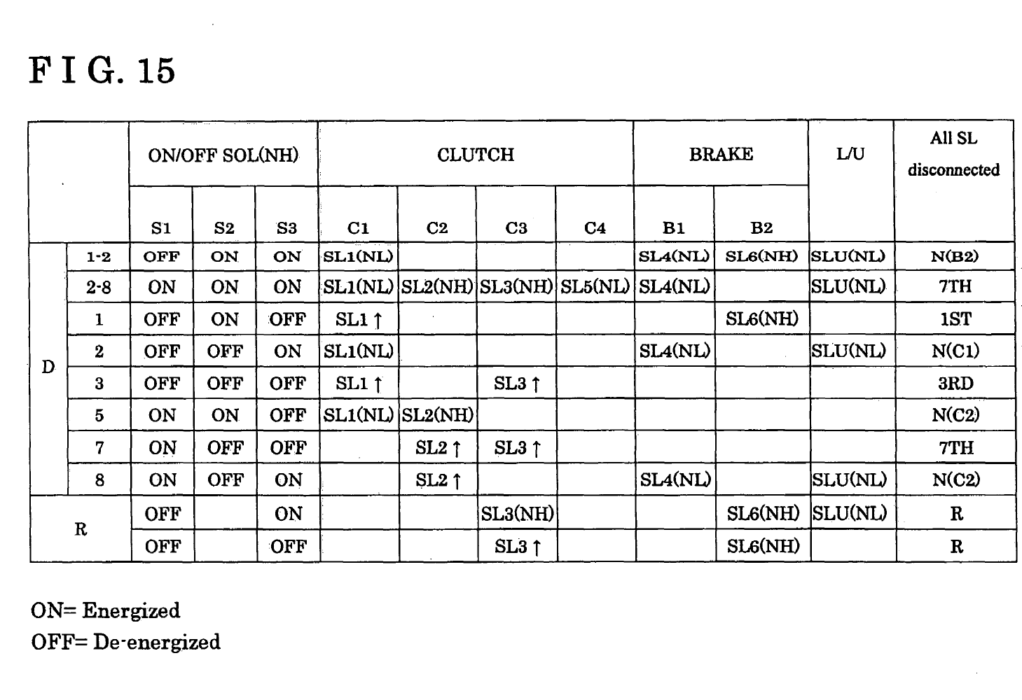

Described below is a hydraulic pressure control apparatus for an automatic transmission according to a sixth embodiment of the present invention, with reference to the attached drawings. FIG. 14 is a hydraulic circuit diagram partially schematically illustrating a structure of a hydraulic pressure control unit according to the sixth embodiment of the present invention. FIG. 15 is a table for explaining a shift pattern at each driving range selected in accordance with a control state of the hydraulic pressure control unit according to the sixth embodiment.

In the fifth embodiment, the output pressure of the sixth control valve unit SL5 is supplied to the sixth switching circuit (32j in FIG. 12) of the first shift valve (32 in FIG. 12). In the sixth embodiment, however, the output pressure of the sixth control valve unit SL6 is supplied to the second frictional brake B2 and the third hydraulic chamber 33f of the second shift valve 33. With this hydraulic circuit, the fourth shuttle valve SB4 is connected to the fourth switching circuit 23j of the first shift valve 32, and the supply port of the sixth control valve unit SL6 is connected to the fifth switching circuit 33k of the second shift valve 33.

In the sixth embodiment, the same effects are yielded as the first, second, third and fourth embodiments.

### Seventh Embodiment

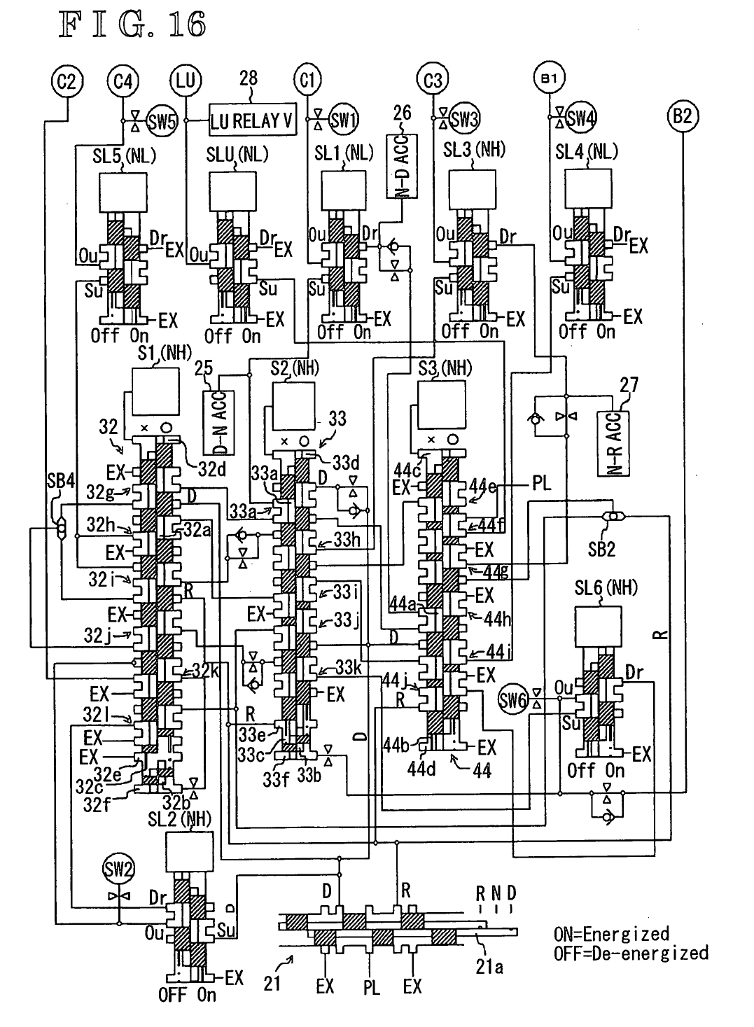

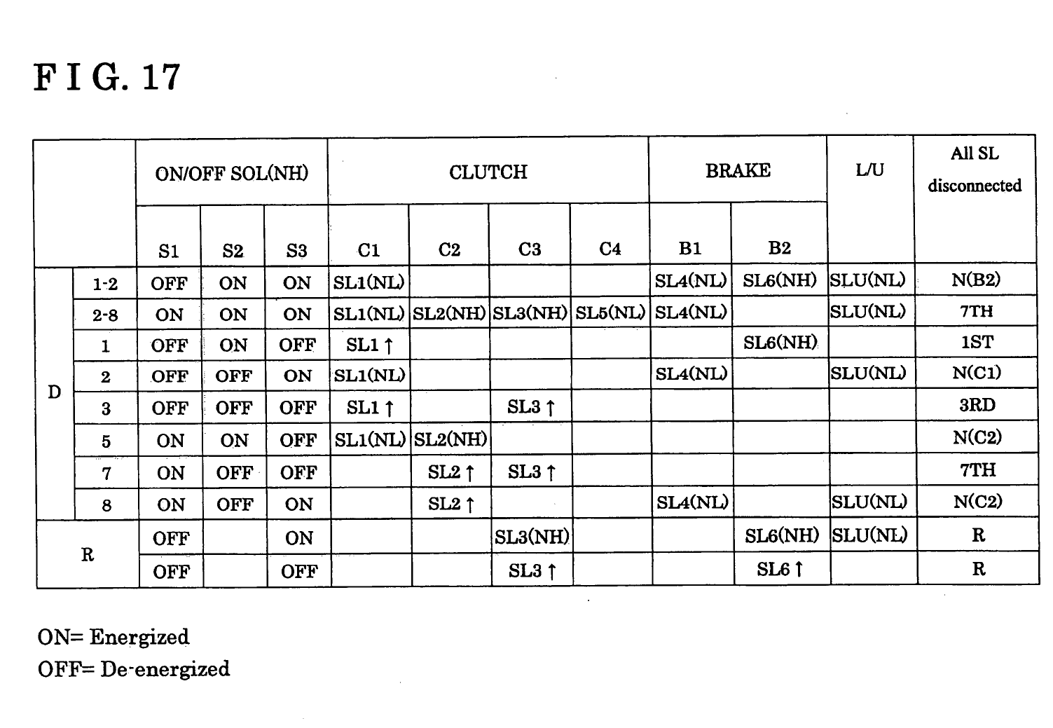

Described below is a hydraulic pressure control apparatus for an automatic transmission according to a seventh embodiment of the present invention, with reference to the attached drawings. FIG. 16 is a hydraulic circuit diagram partially schematically illustrating a structure of a hydraulic pressure control unit according to the seventh embodiment of the present invention. FIG. 17 is a table for explaining a shift pattern at each driving range selected in accordance with a control state of the hydraulic pressure control unit according to the seventh embodiment.

In the seventh embodiment, as illustrated in FIG. 16, the third shift valve 44 is additionally provided with a fifth switching circuit 44i for the purpose of enhancing a driving performance at a reverse shift stage. When the third shift valve 44, i.e., the fifth switching circuit 44i is positioned as denoted with “x” in FIG. 16, the pressure R can be supplied to the drain port of the sixth control valve unit SL6 via the sixth switching circuit 44j.

In the seventh embodiment, the same effect is yielded as the first, second, third and fourth embodiment. As being summarized in FIG. 17, with the on-off solenoid valve S1 in the de-energized state, the on-off solenoid valve S2 in the energized or de-energized state and the on-off solenoid valve S3 in the de-energized state during the R range selected, the vehicle start at the reverse shift stage is enabled even when wire disconnection occurs for all of the control valve units.

In any of the first to seventh embodiments, an oil passage connection and/or an increase or decrease in the number of switching circuits of each shift valve is provided, but there is no other additional component apart from a control valve unit. As a result, a hydraulic apparatus for an 8-speed automatic transmission is structured with a hydraulic apparatus for a 6-speed automatic transmission as a basic structure and with minor changes thereto. Accordingly, even for a farther increase in the number of shift stages to be achieved in an automatic transmission, such increase in the number of shift stages can be achieved by supplying, to the additional control valve unit, the pressure D for the case of the on-off solenoid valves S1, S2 and S3 all in the energized state.

In any of the first to seventh embodiments, the line pressure is supplied to the fifth control valve unit SL5 that controls the fourth frictional clutch C4 only when all of the on-off solenoid valves are in the energized state. Therefore, a fixed shift stage mode for the 4th shift stage and a fixed shift stage mode for the 6th shift stage are not present. As described above, in each first to seventh embodiment, although eight fixed shift stage modes for all of the eight shift stages are not set. Meanwhile, as disclosed in JP2005-163916A, in the case where a fixed shift stage mode is selected during a steady running of a vehicle and a shift mode is selected during a shift operation, the shift valves are required to selectively change oil passages in response to the changes from the steady running to the shift operation and vice versa. Further, it is necessary to consider a time, where a supply of hydraulic pressure to linear solenoid valves, and/or a period of time, where hydraulic pressure supply is cut off. In such circumstances, because the frequency of shift operations is increased in response to the increase in the number of shift stages, a response may be deteriorated. Rather than that, it is preferable that a steady running of a vehicle is maintained under a shift mode so that there is no need to have all fixed shift stages.

Provided that a possible shift stage during electric disconnection failure, is to be set the same as that disclosed in JP2005-163916A, the output pressure of the fifth linear solenoid valve SL5 can be supplied to the third frictional clutch C3 and the output pressure of the third linear solenoid valve SL3 can be supplied to the fourth frictional clutch C4. On the other hand, if a possible shift stage achievable during electric disconnection failure according to the embodiments of the present invention is to be set different from that disclosed therein, it is achieved by slightly increasing the oil passage connections and the switching circuits. For example, a vehicle can run at any of the fixed shift stages regardless of the control valve unit.

### EXAMPLE 1

Described below is the basis of the hydraulic pressure control apparatus for an automatic transmission of the present invention with reference to the attached drawings.

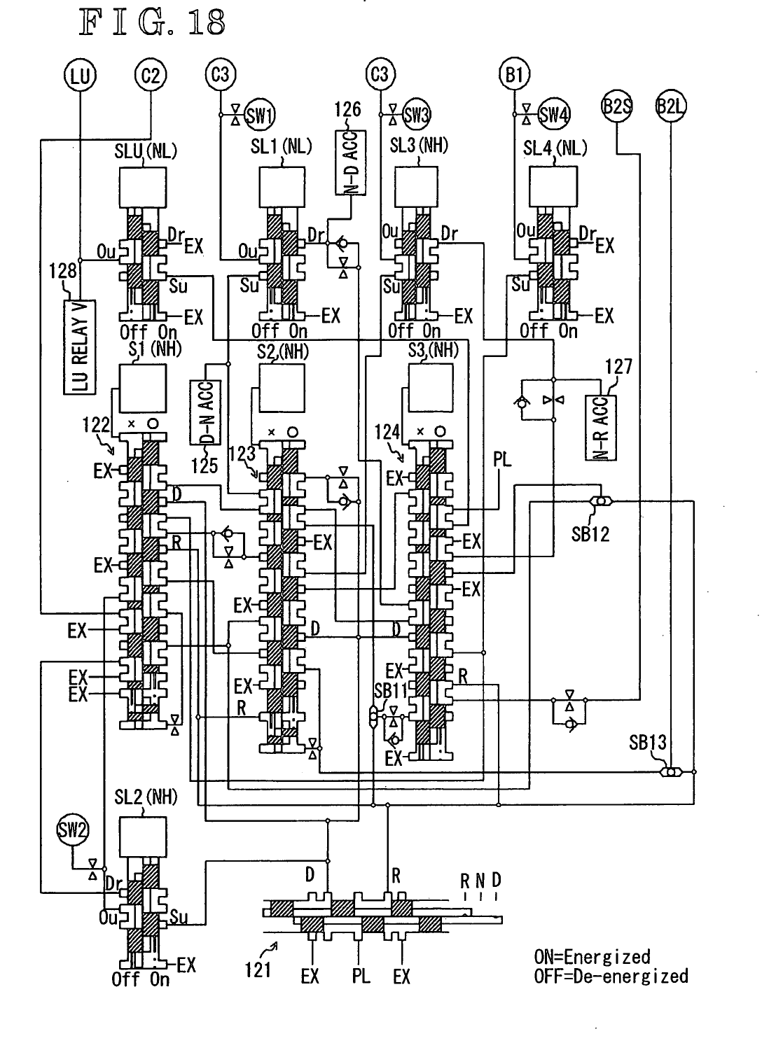

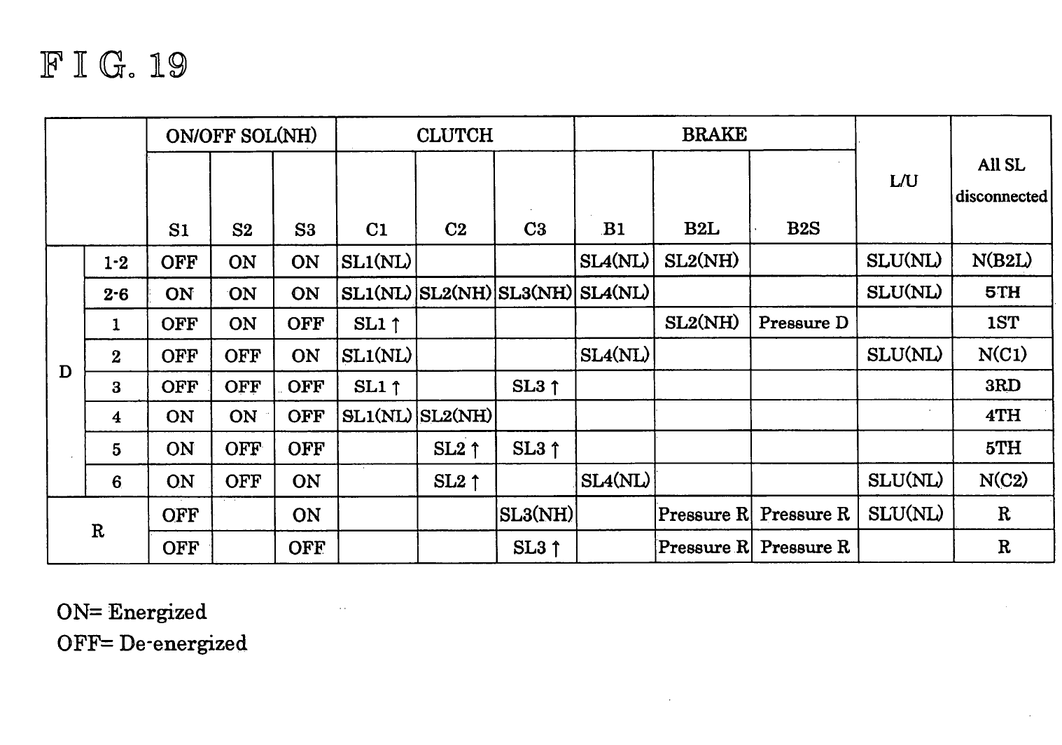

FIG. 18 is a hydraulic circuit diagram schematically illustrating a hydraulic pressure control unit according to an example 1. FIG. 19 is a table for explaining a shift pattern at each driving range selected in accordance with a control state of the hydraulic pressure control unit according to the example 1.

According to a hydraulic circuit of the example 1, the third control valve unit SL3 for the third frictional clutch C3 is controllable during the N range for reduction in the number of accumulator against a conventional work. In the example 1, the hydraulic pressure control apparatus is applicable for a 6-speed automatic transmission (AT) that can establish six forward and single reverse shift stages with five engaging elements. In this case, there is no need to change oil passages even in the situation where all of the control valve units are normally-low type valve units (NL). However, the first shift stage cannot be maintained in the event that all electric disconnections occur while the vehicle is driving at the first shift stage. According to the first embodiment of the present invention, the automatic transmission 1 can establish eight forward shift stages based upon the example 1.

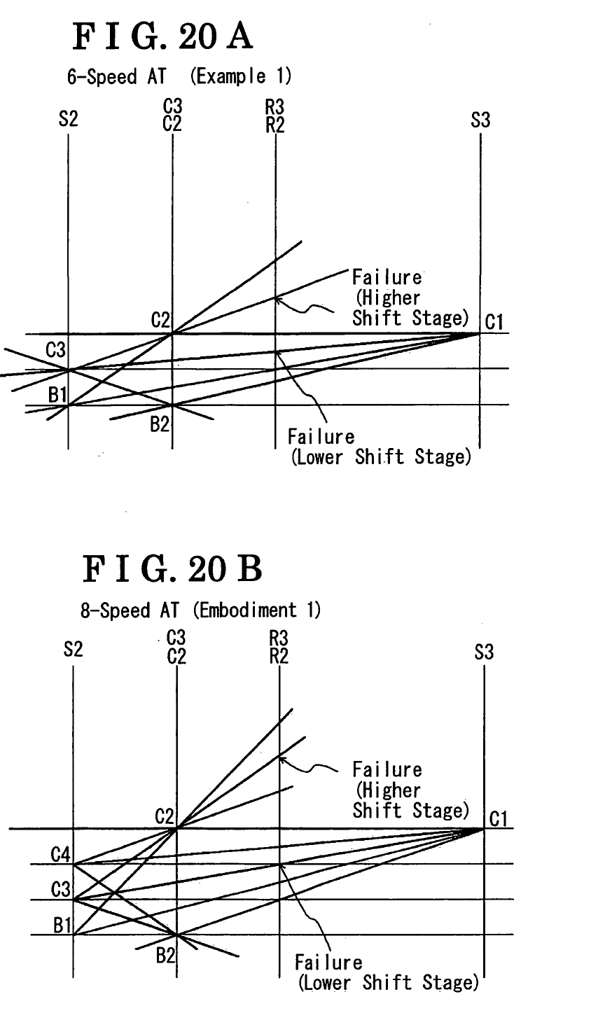

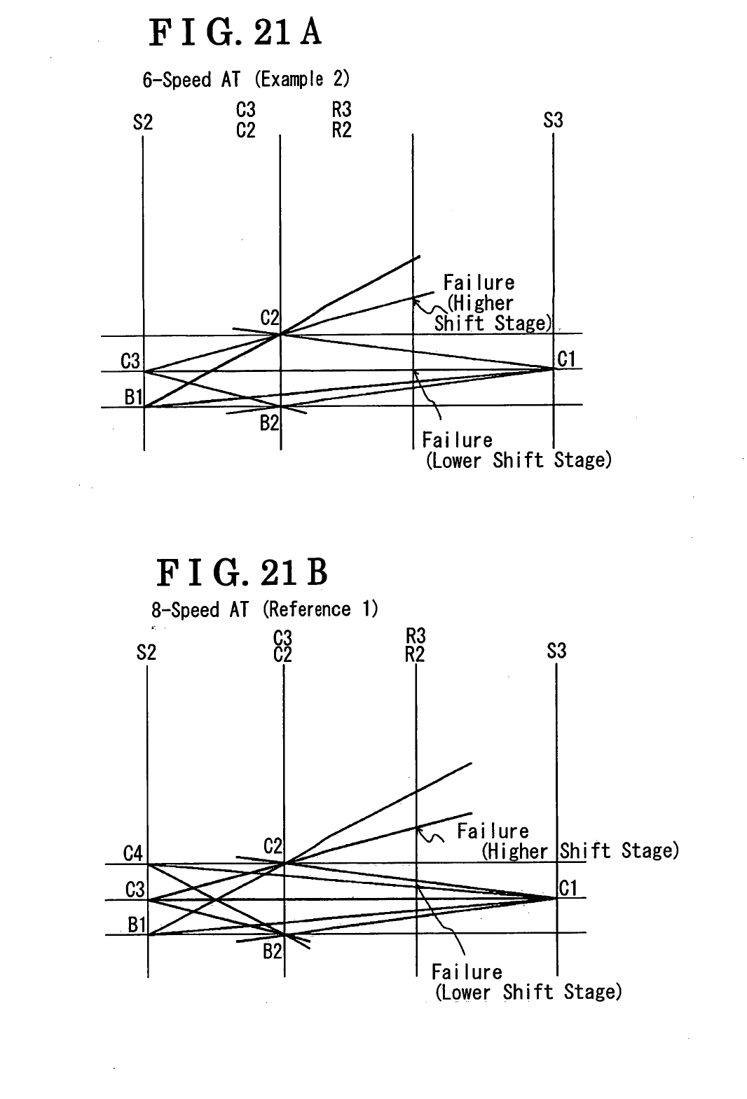

FIG. 20A is a shift operation diagram for a 6-speed AT according to the example 1. FIG. 20B is a shift operation diagram for an 8-speed AT for an 8-speed AT according to the first embodiment. FIG. 21A is a shift operation diagram for a 6-speed AT according to an example 2. In the example 2, the 6-speed AT is achieved based upon Reference 1. FIG. 21B is a shift operation diagram for an 8-speed AT according to Reference 1.

Basically, an 8-speed AT is structured by adding one more engaging element into a 6-speed AT. An AT for further higher shift stages than the 8th shift stage can be structured by adding more engaging elements to a 6-speed AT. That is, comparing with a 6-speed AT that is a basis, a shift stage at a time of higher shift stage or lower shift stage failure is not changed that much.

According to the hydraulic pressure control apparatus for an automatic transmission of the present invention, it is preferable that the line pressure is supplied to at least one of the control valves only when a shift pattern is selected, in which shift pattern all of the on-off solenoid valves are in the energized states.

It is preferable that each shift valve includes a switching circuit which supplies the line pressure via all of the shift valves to at least one of the control valves only when a shift pattern is selected, which shift pattern structures a shift mode having higher shift stages in response to the on-off solenoid valves in the energized or de-energized states.

It is preferable that the automatic transmission includes at least three shift valves, at least three on-off solenoid valves, at least five control valves and at least six engaging elements.

As described above, it is possible to supply a hydraulic pressure apparatus for seven or more shift stages with the components in the same quantity as an apparatus for six shift stages, an additional control valve, and minor changes in the structure of an oil passage for the hydraulic apparatus for six shift stages. That is, with adding a control valve, there is no need to change the basic structure of the hydraulic pressure apparatus, which enables to reduce manufacturing cost and development hours. Further, being different from conventional works, the type of linear solenoid valves for control valves, whether it is NL-type or NH-type, does not affect the structure of the hydraulic pressure apparatus. Still further, there is no possibility that interlock may occur during a fixed shift stage mode due to a primary failure of a failsafe valve, because no failsafe valve is mounted in the apparatus.

The present invention is applicable to a seat for a vehicle in which a seatback is fixed to a seat cushion at a predetermined angle. The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A hydraulic pressure control apparatus for an automatic transmission having a plurality of engaging elements, the apparatus by which a shift stage is switched in accordance with a combination of supplying hydraulic pressure to at least one of the engaging elements and draining hydraulic pressure from at least one of the engaging elements, the apparatus comprising:
a plurality of control valves each generating control hydraulic pressure from line pressure in response to an amount of electric power supplied thereto and controlling engagement or disengagement of at least one corresponding engaging element from among the engaging elements by use of the control hydraulic pressure;
a plurality of shift valves each responsive to be actuated by a signal pressure and selectively establishing an oil passage for supplying the line pressure to each control valve in response to the signal pressure;
a plurality of on-off solenoid valves each controlled in an energized state or in a de-energized state and each switching the signal pressure for a corresponding shift valve from among the plurality of shift valves in response the energized or de-energized state;
a shift mode under which the plural shift valves are actuated to open the oil passages for supplying the line pressure to all of the corresponding control valves in accordance with a combination of the on-off solenoid valves in the energized or de-energized state:
a fixed shift mode under which the plural shift valves are actuated to open at least one of the oil passages for supplying the line pressure to the corresponding control valve so that at least one corresponding engaging element from among the engaging elements is engaged and a shift stage is established in the automatic transmission; and
an additional control valve provided to increase the number of shift stages achievable in the automatic transmission,
wherein the plural shift valves each supply the line pressure to the additional control valve only during the fixed shift mode.

2. A hydraulic pressure control apparatus for an automatic transmission according to claim 1, wherein a hydraulic switch is mounted on an oil passage extending between the additional control valve and a corresponding engaging element.

3. A hydraulic pressure control apparatus for an automatic transmission according to claim 2, wherein all of the on-off solenoid valves are in the energized state during the shift mode.

4. A hydraulic pressure control apparatus for an automatic transmission according to claim 1, wherein all of the on-off solenoid valves are in the energized state during the shift mode.

5. A hydraulic pressure control apparatus for an automatic transmission according to claim 1, wherein at least two of the plural control valves are normally high-type valves that each generate the control hydraulic pressure at a maximum level when electric power is not supplied thereto.

6. A hydraulic pressure control apparatus for an automatic transmission according to claim 2, wherein at least two of the plural control valves are normally high-type valves that each generate the control hydraulic pressure at a maximum level when electric power is not supplied thereto.

7. A hydraulic pressure control apparatus for an automatic transmission according to claim 3, wherein at least two of the plural control valves are normally high-type valves that each generate the control hydraulic pressure at a maximum level when electric power is not supplied thereto.

8. A hydraulic pressure control apparatus for an automatic transmission according to claim 4, wherein at least two of the plural control valves are normally high-type valves that each generate the control hydraulic pressure at a maximum level when electric power is not supplied thereto.

9. A hydraulic pressure control apparatus for an automatic transmission according to claim 5, wherein the normally high-type valves are normally supplied with the line pressure.

10. A hydraulic pressure control apparatus for an automatic transmission according to claim 6, wherein the normally high-type valves are normally supplied with the line pressure.

11. A hydraulic pressure control apparatus for an automatic transmission according to claim 7, wherein the normally high-type valves are normally supplied with the line pressure.

12. A hydraulic pressure control apparatus for an automatic transmission according to claim 8, wherein the normally high-type valves are normally supplied with the line pressure.

13. A hydraulic pressure control apparatus for an automatic transmission according to claim 2, wherein an eighth shift stage is achieved by adding the additional control valve and the corresponding engaging element.

14. A hydraulic pressure control apparatus for an automatic transmission according to claim 3, wherein an eighth shift stage is achieved by adding the additional control valve and the corresponding engaging element.

15. A hydraulic pressure control apparatus for an automatic transmission according to claim 4, wherein an eighth shift stage is achieved by adding the additional control valve and the corresponding engaging element.

16. A hydraulic pressure control apparatus for an automatic transmission according to claim 5, wherein an eighth shift stage is achieved by adding the additional control valve and the corresponding engaging element.

17. A hydraulic pressure control apparatus for an automatic transmission according to claim 8, wherein an eighth shift stage is achieved by adding the additional control valve and the corresponding engaging element.
